(19) United States
(12) Patent Application Publication
(10) Pub. No.: US 2010/0114650 A1
(43) Pub. Date: May 6, 2010

(54) COMPUTER-IMPLEMENTED, AUTOMATED MEDIA PLANNING METHOD AND SYSTEM

(75) Inventors: Daniel D. Sherr, Washington Depot, CT (US); Mary Rainer Stewart, Greenwich, CT (US); Debra L. Donohue, South Windsor, CT (US); Lucy Miller Clark, Tolland, CT (US); Emily A. Westfall, Laurel, MD (US); Karen F. Kula, Woodbury, CT (US); Therese Mulvey, North Granby, CT (US); Chris Kaul, Oxford, MI (US); Alireza Jahan Parvar, Falls Church, VA (US); Erin E. O'Loughlin, Royal Oak, MI (US); Steve Worona, Westland, MI (US); Nancy E. Curmi, South Lyon, MI (US); Karen Strnad, Trenton, MI (US)

Correspondence Address: BROOKS KUSHMAN P.C., 1000 TOWN CENTER, TWENTY-SECOND FLOOR, SOUTHFIELD, MI, 48075, US

(73) Assignee: VALASSIS COMMUNICATIONS, INC., Livonia, MI (US)

(21) Appl. No.: 12/262,806

(22) Filed: Oct. 31, 2008

(51) Int. Cl. G06Q 10/00; G06Q 50/00

(52) U.S. Cl. 705/10

(57) ABSTRACT

An automated computer system for media planning is provided. The automated computer system includes functionality for determining geographically-localized estimated sales data for use in generating media plans. The automated computer system also includes functionality for determining the relative value of a localized geography to a media plan. The automated computer system further includes functionality for a media buyable unit (MBU) score for use in generating a geographically-localized media plan.

### CROSS-REFERENCE TO RELATED APPLICATIONS

This application is related to U.S. patent application Ser. No. ______, filed on ______ and U.S. patent application Ser. No. ______ filed on ______. Both related applications are incorporated herein by reference in their entirely.

### BACKGROUND

1. Technical Field

One aspect of the present invention relates to a computer-implemented, automated media planning method and system.

2. Background Art

Media planning is becoming increasingly more sophisticated in today's information age. Several current proposals for media planning recognize the use of computer-implemented systems to process large amounts of information and to decrease the time necessary for generating a media plan. These computer-implemented systems typically utilize an optimization process to generate media plans.

For instance, U.S. Pat. No. 6,286,005 to Cannon discloses a computer-based decision support system for analyzing optimized media advertising plans relating to paid advertising to television viewing audiences. The system includes an advertising optimization mechanism, which makes adjustments, additions and deletions to a base advertising plan that has been conventionally prepared. The advertising optimization mechanism incrementally modifies a base plan or schedule to more closely meet the set of media objectives defined in the conventionally prepared plan, while considering a number of factors, such as historical viewing data, market, program and audience research. The advertising optimization mechanism outputs an optimized plan or schedule for execution.

As another example, U.S. Pat. Pub. No. 2003/0229536 applied for by House et al. discloses a media planning and buying system and method. House et al. discloses a process, which is implemented by an intelligent media planning engine, for selecting geographically targeted media. The engine receives a user input of a target geographic region, such as a list of ZIP Codes, an area within a selected radius from a point of interest, or by selecting one or more counties. The engine identifies all newspapers or cable television systems, i.e., media vehicles, with an audience in the selected geographic region. The engine determines and displays the percent target coverage of each media vehicle and the unit pricing for each vehicle. The engine is configured to search for media vehicle alternatives within the targeted geography, and to determine whether a broader geographic coverage might be more efficient than the highly targeted options identified in previous steps of the process. The engine also develops alternatives using the costs for any selected newspapers and/or cable systems. The client selects one or more media alternatives, and the client's selections are sent to another system for use in developing a media plan.

Kantar Media Research, a unit of WPP Group, offers the Compose software and service, which includes functionality to measure the contribution of one or more media channels to meeting the communication needs of a brand or company. The Compose software includes functionality for assessing the relative value of general media types, such as radio, television and print advertising. An included feature is the ranking of different media channels in terms of relative strength in building brand awareness. These rankings may be utilized for generating media plans.

### SUMMARY

In one embodiment, an automated computer system for determining geographically-localized estimated sales data for use in generating media plans is disclosed. The system includes a computer having a central processing unit (CPU) for executing machine instructions and a memory for storing machine instructions that are to be executed by the CPU. The machine instructions when executed by the CPU implement the following functions: receiving sales data from a client for a number of ZIP Codes; performing lifestyle cluster analysis on the sales data of the client for the number of ZIP Codes to obtain lifestyle cluster data for each of the number of ZIP Codes; receiving information for a number of carrier routes for each of the number of ZIP Codes; calculating a lifestyle cluster index for each of the number of ZIP Codes and each of the number of carrier routes based on the lifestyle cluster data for each of the number of ZIP Codes and the information for the number of carrier routes; appending household base counts to each of the number of ZIP Codes and each of the number of carrier routes; calculating actual sales per household for each of the number ZIP Code based on the sales data from the client for the number of ZIP Codes and the household base counts for the number of ZIP Codes; and calculating estimated total sales per household for each of the number of carrier routes based on the actual sales per household for the ZIP Code associated with the carrier route being considered, the lifestyle cluster index for the carrier route being considered, and the lifestyle cluster index for the ZIP Code associated with the carrier route being considered.

According to another embodiment, an automated computer system for determining the relative value of a localized geography to a media plan is disclosed. The system includes a computer having a central processing unit (CPU) for executing machine instructions and a memory for storing machine instructions that are to be executed by the CPU. The machine instructions when executed by the CPU implement the following functions: receiving a localized geography and a number of localized geography types; associating one of the localized geography types to the localized geography to obtain an associated localized geography type; receiving a functional relationship related to the associated localized geography type; calculating a geo-score for the localized geography based on the functional relationship; and calculating the relative value of the localized geography based on the geo-score and a household base count for the localized geography.

In yet another embodiment, an automated computer system for generating a media buyable unit (MBU) score for use in generating a geographically-localized media plan is disclosed. The system includes a computer having a central processing unit (CPU) for executing machine instructions and a memory for storing machine instructions that are to be executed by the CPU. The machine instructions when executed by the CPU implement the following functions: receiving a geography to be included in a geographically-localized media plan; receiving information relating to a first and second media product available within the geography; receiving an activation score for the first media product based on the information relating to the first and second media products; receiving a household value score indicative of the value of the geography; receiving a sell price for the first media product within the geography; and calculating an MBU score for the first media product based on the activation score, the household value score and the sell price. In this embodiment, the activation score indicates the value of the first media product relative to the second media product.

These and other aspects of the present invention will be better understood in view of the attached drawings and following detailed description of the invention.

### BRIEF DESCRIPTION OF THE DRAWINGS

The accompanying drawings, which are incorporated in and constitute a part of the specification, illustrate one or more embodiments of the present invention. These drawings, together with the general description given above and the detailed description of the one or more embodiments given below, are intended to explain the principles of the invention and do not limit its scope, which is solely determined by its claims.

FIG. 1 is an environment, i.e., a computer system, suitable for implementing one or more embodiments;

FIG. 2 is a process map including a number of modules for determining a number of media planning recommendations according to one or more embodiments;

FIG. 3 is a process map relating to a discovery module according to one or more embodiments;

FIG. 4 is an example of a product preference graphical user interface (“GUI”) according to one or more embodiments;

FIG. 5 is an example of a product preference detail GUI for direct mail insert packages according to one or more embodiments;

FIG. 6 is an example of a product preference detail GUI for newspaper inserts according to one or more embodiments;

FIG. 6B is an example of product preference detail GUIs for ZICs, REDPLUM wraps and solo mail packages according to one or more embodiments;

FIG. 7 is an example of a product preference detail GUI for run of press products according to one or more embodiments;

FIG. 8 is an example of a product preference detail GUI for cooperative free-standing inserts according to one or more embodiments;

FIG. 9 is a process map relating to a targeting module according to one or more embodiments;

FIG. 10 is a flowchart depicting the steps for determining geographically localized data according to one or more embodiments;

FIG. 11 is a flowchart depicting the steps for determining a geo-score according to one or more embodiments;

FIG. 12 is a an example of several different geo-units according to one or more embodiments;

FIG. 13 is a process map relating to a media availability (“MAA”) module according to one or more embodiments;

FIG. 14 is a flowchart of steps that are executed by an MAA module according to one or more embodiments;

FIG. 15 is an example of a flowchart depicting the steps for determining an activation score according to one or more embodiments;

FIG. 16 is a process map relating to an optimization module according to one or more embodiments;

FIG. 17 depicts a schematic diagram illustrating the use of an optimization algorithm to obtain an optimized media plan according to one or more embodiments;

FIGS. 18A and 18B depict a flowchart for implementing a greedy-type algorithm with an objective function according to one or more embodiments;

FIG. 19 depicts a process map relating to an evaluation module according to one or more embodiments;

FIGS. 20A and 20B depict an example of an executive summary report according to one or more embodiments;

FIGS. 21A and 21B depict an example of a product detail comparison report according to one or more embodiments; and

FIG. 22 depicts an example of a common geodetail report according to one or more embodiments.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The media planning proposals to date fall short of providing an automated computer system for providing geographically-localized, optimized media planning for use by clients in integrated national media planning. U.S. Pat. No. 6,286,005 to Cannon is limited to making adjustments to a base advertising plan that has been conventionally prepared. The advertising plans generated by Cannon relate to paid advertising to television viewing audiences. The plans are not geographically-localized in the sense of one or more embodiments of the present invention, which consider two or more geographically-localized regions of different sizes for the same media product option. U.S. Pat. Pub. No. 2003/0229536 applied for by House discloses an intelligent media planning engine for selecting geographically targeted media. The engine selects available media vehicles that satisfy the client's targeting input. The available media vehicles are presented to the user for development of the media plan. The intelligent media planning engine of House does not automatically generate a geographically-localized, optimized media plan based on the available media vehicles, the client input and other information, as provided by one or more embodiments of the present invention. The Compose software is limited to functionality for assessing the relative value of general media types. One or more embodiments of the present invention are related to determining the relative value of specific geographic units of media product option units, and using the relative values to generate geographically-localized, optimized media plans. In light of the foregoing, one or more embodiments of the present invention address one or more of the shortcomings of the prior proposals by providing clients geographically-localized, optimized media plans as set forth herein.

### I. System Overview

In one or more embodiments of the present invention, a computer-implemented, automated media planning method and system is disclosed. In one embodiment, an automated computer system for generating a geographically-localized media plan including a number of selected media buyable units (MBUs) is provided. The system implements the following functions: receiving client-defined information and a number of business rules; receiving a number of MBUs each having a relative value and including a first and second MBU associated with a first media product option and a third and fourth MBU associated with a second media product option; applying an optimization algorithm to the client-defined information, the number of business rules and the number of MBU relative values to obtain a number of selected MBUs included in a geographically-localized media plan; and outputting the geographically-localized media plan for use by a client in media planning. The first MBU associated with a first geography. The second MBU is associated with a second geography and the first geography, with the first geography being larger than the second geography and the first geography substantially covering the second geography.

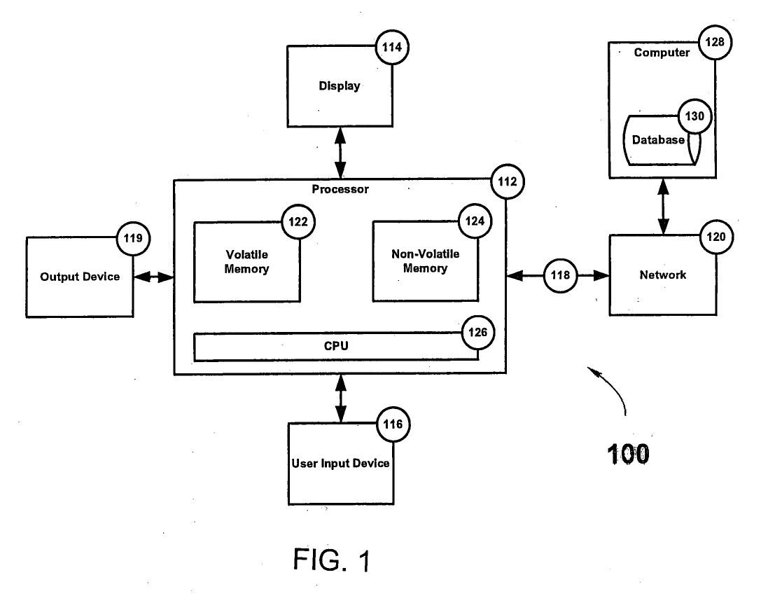

One apparatus embodiment for implementing one or more embodiments of the present invention is illustrated in FIG. 1. It should be readily understood by those of skill in the art that the apparatus may vary significantly from the example shown, based on the rapid advances in technology that are ongoing in this field. The example shows an embodiment including a computer system using a networked client-server database system architecture with a number of computer nodes or computer workstations. Computer workstation nodes would be very similarly configured. In addition to the server and workstation nodes, system nodes also may include output devices.

According to FIG. 1, computer system 100 includes processor 112, display 114, user input device 116, communication line 118, output device 119 and network 120.

Processor 112 includes volatile memory 122, non-volatile memory 124 and central processing unit (CPU) 126. Non-limiting examples of non-volatile memory include hard drives, floppy drives, CD and DVD drives, and flash memory, whether internal, external, or removable. Volatile memory 122 and/or non-volatile memory 124 can be configured to store machine instructions and data relating to media planning. CPU 126 can be configured to execute machine instructions to implement functions of the present invention, for example, receiving data, computing results based on the received data, and formatting received data and computed results for display. For example, the machine instruction can implement one or more steps of any system and method for determining a media plan as disclosed.

A user can use display 114 of processor 112 to view and/or edit data and results according to one or more methods disclosed herein. A non-limiting example display 114 is a color display, e.g., a liquid crystal display (LCD) monitor or cathode ray tube (CRT) monitor.

The user input device 116 can be utilized by a user to input instructions to be received by processor 112. The instructions can be instructions for viewing and editing data and results related to the methods disclosed herein. The user input device 116 can be a keyboard having a number of input keys, a mouse having one or more mouse buttons, a touch pad or a trackball or combinations thereof.

Processor 112 can be configured to be interconnected to network 120, through communication line 118, for example, a local area network (LAN) or wide area network (WAN), through a variety of interfaces, including, but not limited to dial-in connections, cable modems, high-speed lines and hybrids thereof. The network 120 can be configured to link computer system 100 with other computer systems, such as computer system 128, including database 130. Firewalls can be connected in the communication path to protect certain parts of the network from hostile and/or unauthorized use.

Processor 112 can support TCP/IP protocol, which has input and access capabilities via two-way communication lines 118. The communication lines can be an intranet-adaptable communication line, for example, a dedicated line, a satellite link, an Ethernet link, a public telephone network a private telephone network, and hybrids thereof. The communication lines can also be intranet-adaptable, intranet-accessible and/or internet accessible. Examples of suitable communication lines include, but are not limited to, public telephone networks, public cable networks and hybrids thereof.

### II. Module Overview

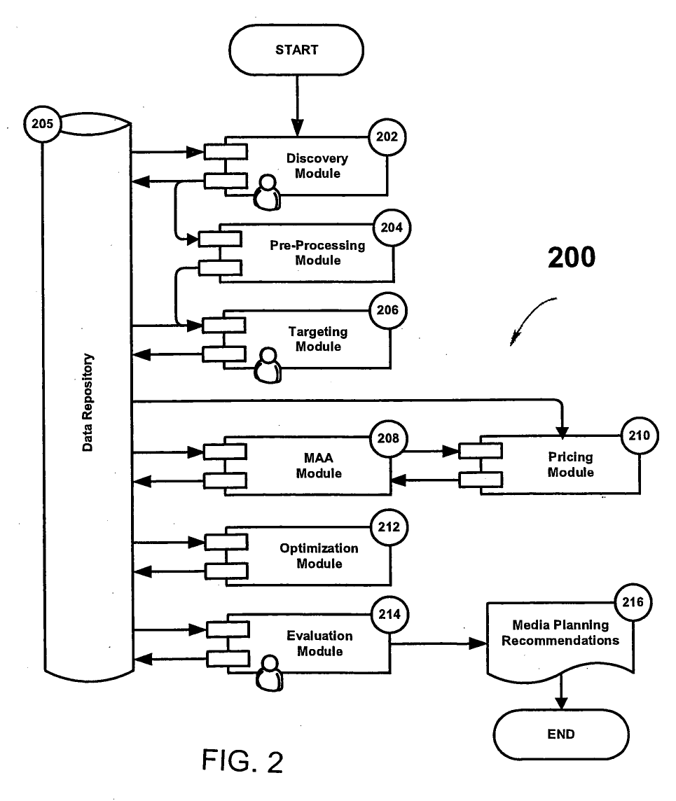

FIG. 2 depicts a process map 200 including a number of modules for determining a number of media planning recommendations according to one or more embodiments of the present invention. Process map 200 may be implemented using computer system 100 of FIG. 1.

The process map 200 starts at discovery module 202. In one or more embodiments, discovery module 202 transmits one or more requests for client information sufficient to define a client's request for media planning recommendations. Discovery module 202 may transmit a request for at least a portion of this information to pre-processing module 204. Pre-processing module 204 transmits data and information from discovery module 202 in response to the request transmitted from discovery module 202.

The data and information captured by the discovery module 202 is transmitted to and stored into data repository 205, for use by targeting module 206. It should be appreciated that various forms of data repositories can be utilized as data repository 205. Non-limiting examples include a single database, a combination of a number of databases, a file a number of files, or any combination thereof.

In one or more embodiments, targeting module 206 determines client-targeted geography in the form of marketing and/or targeting footprints based on client audience information captured by the discovery module 202. In one or more embodiments, targeting module 206 scores the client-targeted geography to obtain scored client-targeted geography.

The data and information generated by targeting module 206 is transmitted to and stored into data repository 205, for use by media availability assessment (MAA) module 208. In one or more embodiments, MAA module 208 determines a number of media products consistent with a number of client objectives, a number of client preferences, and a number of date and other requirements. In one more embodiments, the number of media products are indexed based on a number of business rules. MAA module 208 may transmit a request for pricing information relating to one or more of the number of media products to pricing module 210. Pricing module 210 transmits data and information to MAA module 208 in response to the request transmitted from MAA module 208. The pricing module receives media inventory information and media pricing information from data repository 205.

The data and information generated by MAA module 208 is transmitted to and stored into data repository 205, for use by optimization module 212. In one or more embodiments, optimization module 212 determines a number of media planning recommendations for a number of scenarios based on media buyable unit scores, client information and business rules through application of an optimization algorithm.

The data and information generated by optimization module 212 is transmitted to and stored into data repository 205, for use by evaluation module 214. In one or more embodiments, evaluation module 214 generates one or more reports and one or more maps based on the data and information generated by optimization module 212. The one or more reports and one or more maps are output as media planning recommendations, as depicted by block 216.

### III. Discovery and Pre-Processing Modules

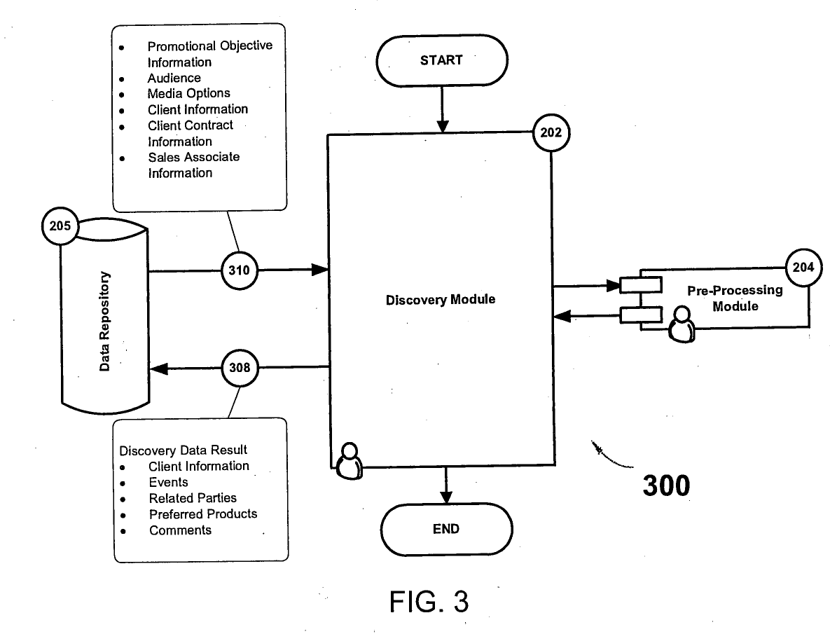

FIG. 3 depicts a process map 300 relating to discovery module 202 according to one or more embodiments of the present invention. Discovery module 202 receives client data and information from various sources. For example, discovery module 202 may receive client data and information from data repository 205. Such client data and information may include client contact information and sales associate information.

Other client data and information that may be received by discovery module 202 from data repository 205 includes, but is not limited to, team information, request information, client information, agency information, industry information, promotional period, contact information, promotion objective, project description, consumer purchasing frequency, promotion reinforcement, promotion budget, annual frequency, product preferences, allocation percentages, if any, and exclusions, audience definition, market definition, store/site list, trade area definition, inclusions, competitor information and deliverables. Non-limiting examples of team information include sales associate, requester and targeter. Non-limiting examples of request information include request due date, client due date and request title. Agency information may include name, customer number and address of an existing agency.

In one or more embodiments, pre-processing module 204 includes functionality to request and obtain information and data relating to product specific client preferences and exclusions, product selections and target audience information. Product specific client preferences include, but are not limited to, product type, product size, frequency, advertisement content, circulation types, rate overrides, page counts and print information. In one or more embodiments, this information and data is stored into data repository 205.

In one or more embodiments, the pre-processing module 204 is configured to review a client's request for media planning recommendations so that the client's request is understood and well defined. The reviewing activities may include reviewing promotion objectives, product preferences, target audiences, trade area definition and output requirements. Further, the pre-processing module 204 may be configured to format data and information received by pre-processing module 204 into appropriate and acceptable formats for downstream processing by other modules included in process map 200. Such formatting may include cleansing client-supplied data files, geocoding, e.g., adding latitude and longitude coordinates to site files, and formatting and loading budget allocations by store and/or market and media exclusions. The pre-processing module 204 may also be configured to verify target audiences by identifying superior predictive variables, and verifying trade area definition. The data and information output from the pre-processing module 204 is transmitted to and received by the targeting module 206.

Discovery module 202 is configured to process received client information and data to generate discovery data and information. Received client data and information may include promotional objective information, audience information and media options, as generally depicted by arrow 310. Discovery data and information may include client information, event information, related parties information, preferred products information, and comments information, as generally depicted by arrow 308. Discovery module 202 is configured to transmit the discovery data and information to data repository 205, which is configured to store the discovery data and information in data repository 205.

Discovery module 202 is configured to receive client media preference information. In one embodiment, a number of graphical user interfaces (GUIs) is utilized to obtain the client media preference information. The client media preference information includes one or more media products selected by the client from a number of media products for consideration in one or more recommended media plans produced by optimization module 212. The client media preference information may also include one or more media products specifically excluded from consideration in any of the recommended media plans produced by optimization module 212. The client media preference information may also include client preferences between alternative media products. For example, a client may express a preference for a major audited daily newspaper over major daily newspapers that are not audited. Further, the client may express a preference for considering local community papers.

In one or more embodiments, the number of media products may be separated into a number of different media channels, such as newspapers and direct mail, which are but two examples of media channels contemplated by the present invention. Non-limiting examples of other media channels include, without limitation, radio advertising, television advertising, in-store advertising, outdoor billboards, magazine advertising and toll free numbers. A number of specific media products within each media channel may be identified and considered for inclusion in a recommended media plan according to one or more embodiments.

In certain embodiments, the number of specific media products may be separated into a number of tiers. For example, two tiers may be defined as a base tier and an advanced tier. The base tier may include products that are always considered by the optimization module 212. The advanced tier may include media products that are considered by the optimization module 212 upon client request.

In one embodiment, base tier media products may include solo mail packages, direct mail inserts, newspaper inserts, zoned insert cards (“ZICs”), REDPLUM wraps, run of press (“ROP”) and cooperative free standing inserts. In one or more embodiments, a solo mail package refers to printed media carrying postage, such as an envelope containing printed media and carrying postage, or a postcard. In one or more embodiments, a direct mail insert refers toone or more pieces of printed media inserted into a mail package whose postage is shared. In one or more embodiments, a newspaper insert refers to one or more pieces of printed media inserted into a newspaper. In one or more embodiments, a ZIC refers to a postcard shaped insert including a marketing and/or informational message. In one or more embodiments, a REDPLUM wrap refers to a wrapthat contains advertisements from a number of advertisers who cooperatively share the space and cost of the wrap package. In one or more embodiments, a ROP refers to advertising within the body of a printed newspaper. In one or more embodiments, a cooperative free standing insert refers to an insert package that contains advertisements from a number of advertisers who cooperatively share the space and cost of the insert package.

In one embodiment, advanced tier media products may include Newspac® advertisements, polybag advertisements, direct-to-door advertisements, in-store advertisements, selective insertion advertisements, solo direct advertisement and eMarketing. In one or more embodiments, a Newspac® advertisement refers to a single-advertiser, multi-page brochure containing a removable flat-pack sample, which is bundled into the insert section of a newspaper. In one or more embodiments, a polybag advertisement is a plastic bag for carrying a newspaper in which the outer surface of the plastic bag includes an advertising message, and optionally, a pouch for product samples and/or a coupon. In one or more embodiments, a direct-to-door advertisement is a sampling or product advertising placed directly at a consumer's residence. In the case of a sampling, the sample may be contained in a door hang bag or box. In the case of product advertising, the direct-to-door advertisement may be in the form of a door hang card. In one or more embodiments, an in-store advertisement may include one or more of the following advertising programs: Moms Matter affinity program, Insignia POPSigns® signs and REDPLUM PERIMETER advertisements. Moms Matter® affinity program is a national co-operative program that utilizes an in-store welcome package containing useful coupons, product samples and/or literature that is distributed to mothers. Insignia POPSigns® signs are full-color signs tat combine consumer packaged goods product manufacturers information with retailers' logos and pricing information to produce a powerful shelf-edge “call to action” sign. REDPLUM PERIMETER advertisements may refer to pre-sale advertisements that provide relevant offers to consumers, driving traffic, sales and profits in the perimeter and throughout the retail stores. In one or more embodiments, REDPLUM PERIMETER advertisements include pre-printed coupons distributed through weighing scales and/or on-demand printed coupons distributed through weighing scales. In one or more embodiments, a solo direct advertisement refers to a printed advertisement, such as a postcard, letter or brochure delivered as a single piece of mail via the United States Post Office and bearing an individual address. In one or more embodiments, eMarketing refers to banner advertisement design, targeting, placement and reporting and/or e-mail marketing programs.

Discovery module 202 is configured to receive client constraint information. In one embodiment, a number of graphical user interfaces (GUIs) is utilized to obtain the client constraint information. The client constraint information may include client budget constraint information, such as (1) cannot spend more than total client budget; (2) must satisfy market allocations; and (3) must satisfy store allocations, if at all possible. The client constraint information may also include required geo-units such as home geo-units and other geounits. The client constraint information may also include minimum volumes for a newspaper or edition, newspaper groups for ROP, limitations on saturation products, avoidance of total penetration beyond a certain percentage for any given geo-unit, and avoidance of total newspaper penetration beyond a certain percentage for any given geo-unit.

Discovery module 202 is also configured to receive client objective information for a media plan. In one embodiment, the client objective is selected from a number of client objectives, including conversion, retention, awareness, acquisition, frequency or ticket. These client objectives are defined below in the targeting module section.

Discovery module 202 is also configured to receive data relating to a two dimensional matrix of the client objectives and industry categories as identified below. The two dimensional matrix is defined below in the targeting module section.

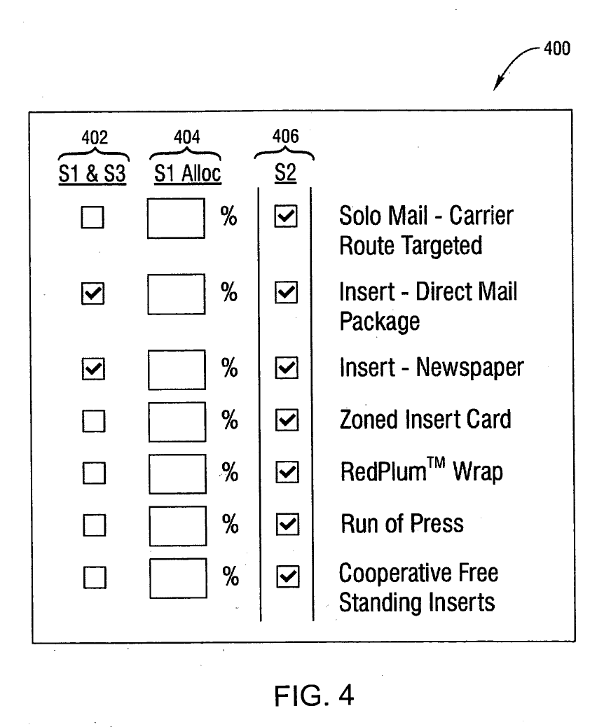

FIG. 4 is an example of GUI 400 for obtaining data and information relating to a client's product preferences according to one embodiment. As depicted in FIG. 4, all of the tier one products are displayed, however, it should be understood that any number of media product options may be displayed through a product preferences GUI.

GUI 400 includes a check box 402 situated to the far left of each media product option, and an allocation input field 404 situated to the intermediate left of each media product option. By selecting the check box 402, the corresponding media option is considered as part of the client preference and flexed client preference media scenarios during the execution of the optimization module 212. The allocation input field 404 is activated upon selecting the check box. An allocation percentage is input into the allocation input field. The sum of the allocation percentages is equal to 100%. The check box 406 to the immediate left indicates which media products will be considered for the full portfolio scenario. By default all products will be selected. To exclude a product from optimization module consideration, that product is deselected by unchecking a 406 check box.

Upon selecting a check box 402 for one of the media product options, a product preference detail GUI is dynamically and automatically displayed adjacent to the product preference GUI 400. The product preference detail GUIs prompt and obtain data and information utilized by other modules of computer system 200. The product preference detail GUIs are utilized to obtain a number of attributes relating to one or more specific media product option. In one or more embodiments, such data and information is stored to data repository 205.

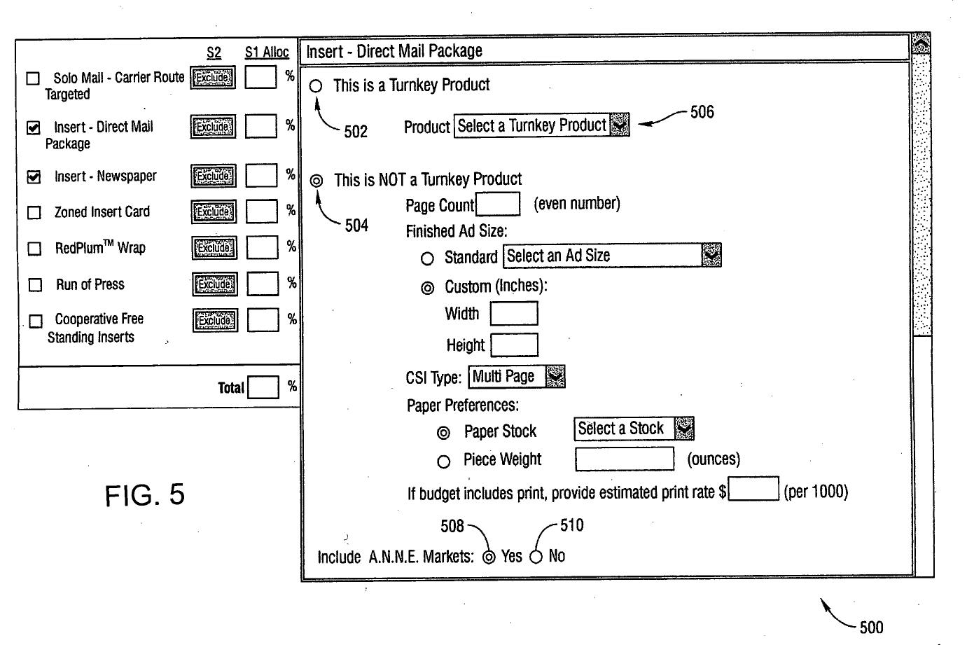

FIG. 5 is an example of a product preference detail GUI 500 for direct mail insert packages according to one embodiment. GUI 500 includes turnkey radio buttons 502 and 504. Turnkey entries are activated and non-turnkey entries are deactivated upon selecting radio button 502. One turnkey entry is turnkey product dropdown menu 506. In one embodiment, dropdown menu 506 includes “The Premium Postcard” and “The Promo Reply Card” as the turnkey product possible selections. Non-turnkey entries are activated and turnkey entries are deactivated upon selecting radio button 504. In one embodiment, the non-turnkey entries include page count, finished advertisement size, client supplied insert (“CSI”) type, paper preference, paper thickness and print rate. According to FIG. 5, GUI 500 includes yes and no radio buttons 508 and 510 for the Allied National Network Extension (“A.N.N.E.”) market inclusion. In one embodiment, the A.N.N.E. market inclusion is obtained for turnkey and non-turnkey products. A.N.N.E. refers to an association of local and regional shared mail services to rural areas. In one or more embodiments, a CSI refers to an advertising piece that the client prints and delivers for insertion into a direct mail package and/or newspaper.

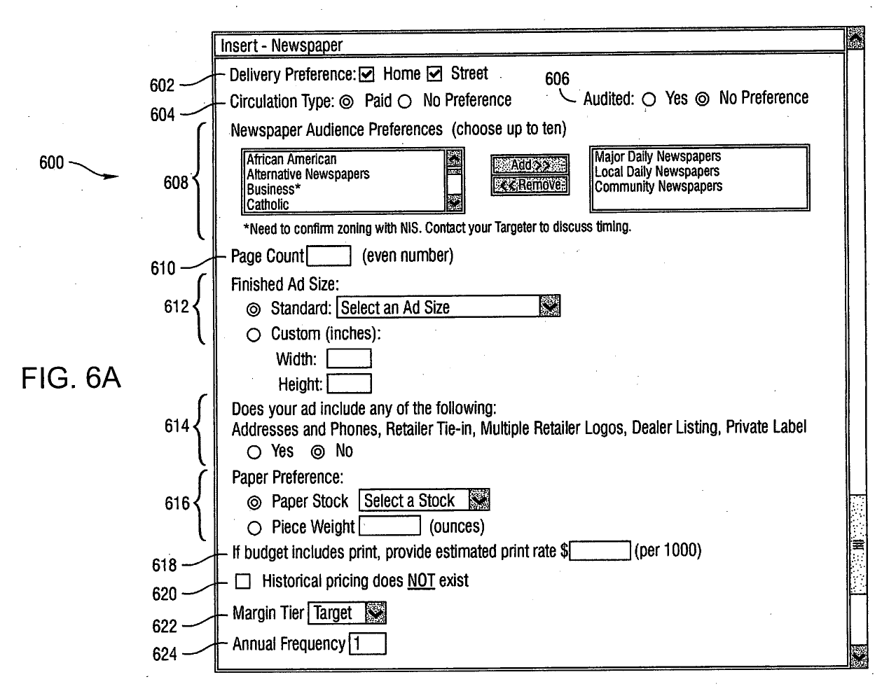

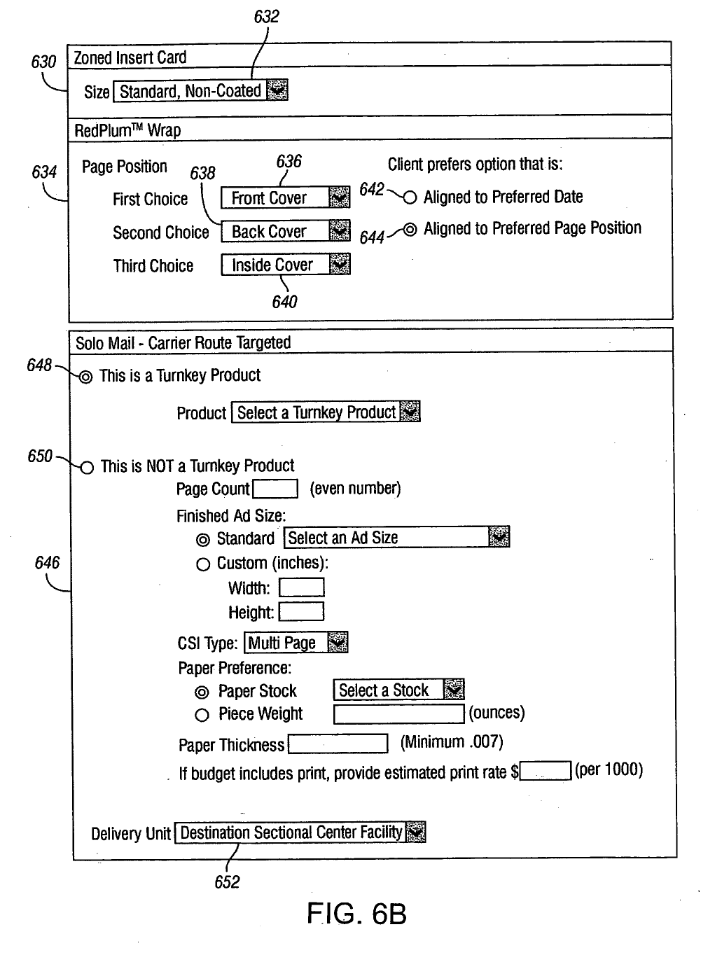

FIG. 6 is an example of a product preference detail GUI 600 for newspaper inserts according to one embodiment. GUI 600 includes entry mechanisms for selecting delivery preference 602, circulation type 604, audited flag 606, newspaper audience preference 608, page count 610, finished advertisement size 612, advertisement inclusion flag 614, paper preference 616 (which may include page positions), print rate 618, historical pricing 620, margin tier 622 and annual frequency 624 for the number of client events that will utilize the media product option. In one or more embodiments, the advertisement inclusion flag 614 refers to whether the advertisement in question includes any addresses and phones, retailer tie-in, multiple retailer logos, dealer listings, and/or private labels. If the advertisement includes any of these items, then the insert rate charged by a newspaper may be affected. In one or more embodiments, the inclusion of 800 numbers does not impact the insert rate charged. The selection of the click box for historical pricing 620 sets a flag so that historical pricing is by-passed when calculating client rates.

In one or more embodiments, the product preference detail GUI 630 of FIG. 6B for ZICs may include a size drop down box 632. The dropdown box may include “Junior,” “Standard, Non-Coated,” and “Standard, Coated.”

In one or more embodiments, the product preference detail GUI 634 of FIG. 6B for REDPLUM wrap includes dropdown boxes for first, second and third choices 636, 638 and 640 for advertisement placement. Each of the dropdown boxes may include the following selectable values: “Front Cover,” “Back Cover,” and “Inside Page.” The GUI may also include radio buttons 642 and 644 to indicate whether the client prefers an option that is closer to the preferred date or preferred page position, should preferred page not be available on the preferred date.

FIG. 6B is an example of a product preference GUI 646 for solo mail packages according to one embodiment. GUI 646 includes turnkey radio buttons 648 and 650. Turnkey entries are activated and non-turnkey entries are deactivated upon selecting radio button 648. One turnkey entry is the turnkey product dropdown menu. In one embodiment, the dropdown menu includes “The Premium Postcard” and “The Promo Reply Card” as the turnkey product possible selections. GUI 646 also includes a delivery unit dropdown menu. In one embodiment, the delivery unit possible selections are “Destination Delivery Unit”, “Destination Sectional Center Facility”, and “Destination Bulk Mail Center”. Non-turnkey entries are activated and turnkey entries are deactivated upon selecting radio button 650. In one embodiment, the non-turnkey entries include page count, finished advertisement size, client supplied insert (“CSI”) type, paper preference, paper thickness and print rate. GUI 646 also includes delivery unit drop down box 652 to select the delivery unit.

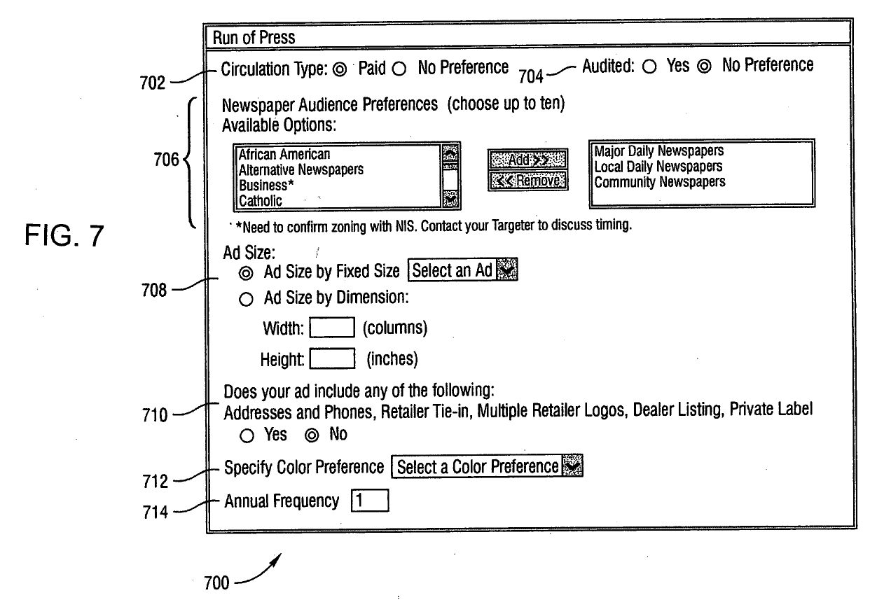

FIG. 7 is an example of a product preference detail GUI 700 for ROP according to one embodiment. GUI 700 includes entry mechanisms for selecting circulation type 702, audited flag 704, newspaper audience preference 706, advertisement size 708, advertisement inclusion flag 710, color preference 712 and annual frequency 714 of the number of client events that will utilize the media product option. In one or more embodiments, the advertisement inclusion flag 710 refers to whether the advertisement in question includes any addresses and phones, retailer tie-ins, multiple retailer logos, dealer listings, and/or private labels. In one or more embodiments, the inclusion of 800 numbers does not impact the insert rate charged. If the advertisement includes any of these items, then the insert rate charged by a newspaper may be affected.

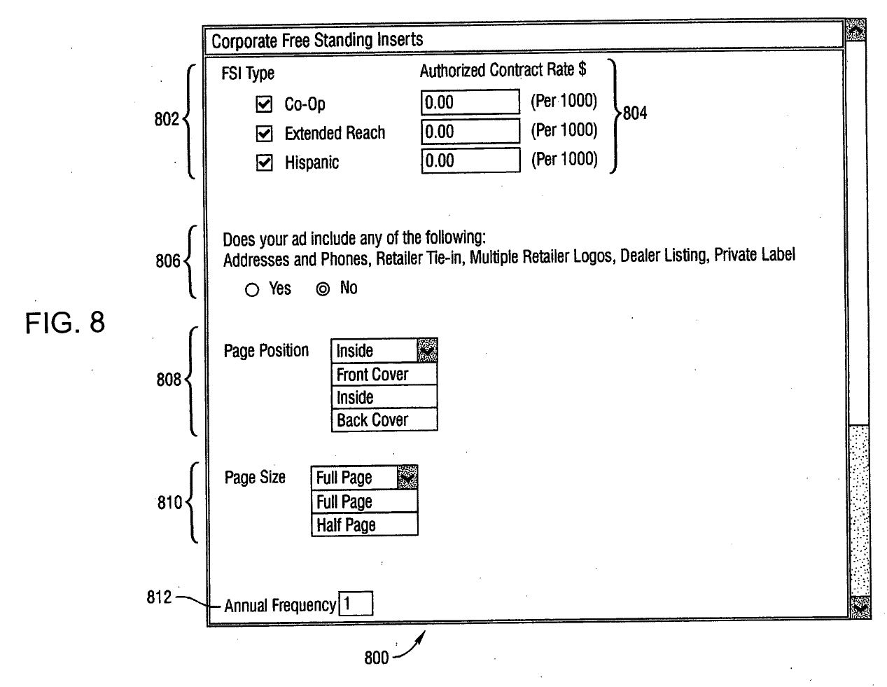

FIG. 8 is an example of a GUI 800 for cooperative free standing inserts according to one embodiment. GUI 800 includes entry mechanisms for selecting FSI type 802, authorized contract rate 804, advertisement inclusion flag 806, page position 808, page size 810 and annual frequency 812 of the number of client events that will utilize the media product option. In one or more embodiments, the advertisement inclusion flag 806 refers to whether the advertisement in question includes any addresses and phones, retailer tie-in, multiple retailer logos, dealer listings, and/or private labels. In one or more embodiments, the inclusion of 800 numbers does not impact the insert rate charged. If the advertisement includes any of these items, then the insert rate charged by a newspaper may be affected.

### IV. Targeting Module

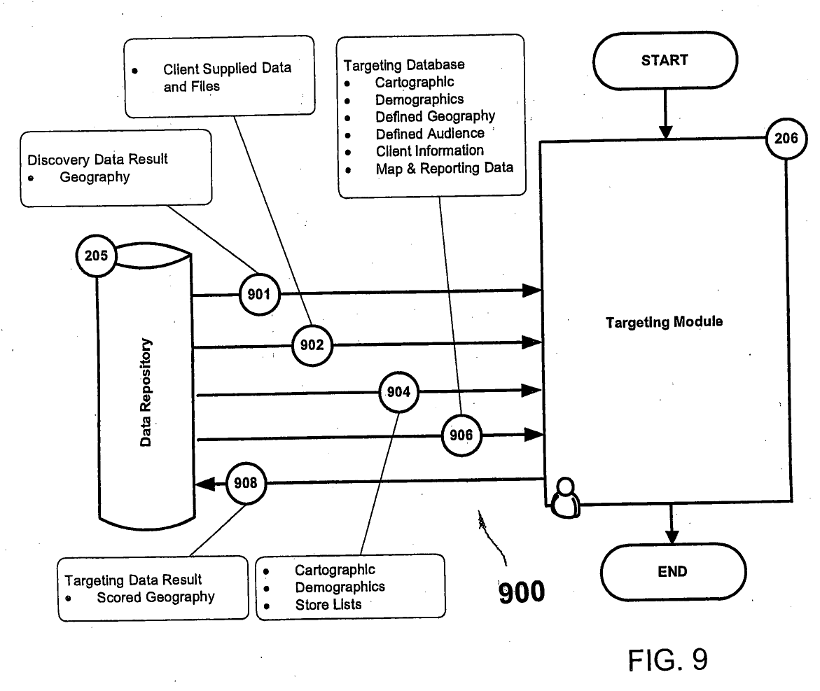

FIG. 9 depicts a process map 900 relating to targeting module 206 according to one or more embodiments of the present invention. Targeting module 206 receives data and information from data repository 205. For example, targeting module 206 receives discovery data and information, including geography data, as depicted by arrow 901, from data repository 205. Targeting module 206 may also receive client supplied data and files as depicted by arrow 902, from data repository 205. Targeting module 206 may also receive data and information relating to cartographics, demographics and store lists, as depicted by arrow 904, from data repository 205. Targeting module 206 receives data and information relating to cartographics, demographics, defined geographies, defined audiences, client information, client data and map and reporting data, as depicted by arrow 908, from data repository 205. Targeting module 206 is configured to transmit scored geographies data and information to data repository 205.

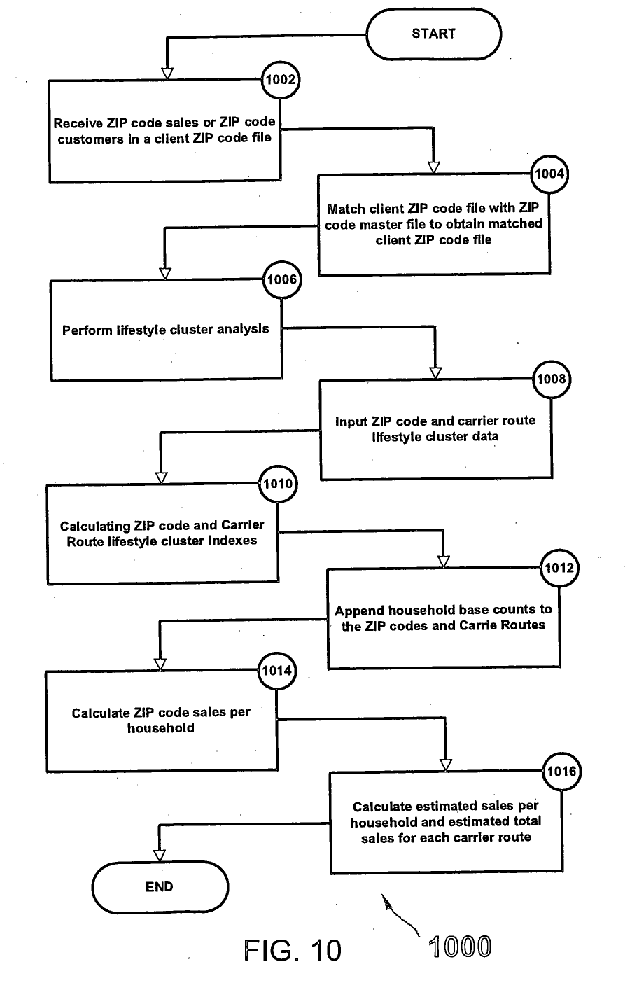

Targeting module 206 is configured to process received data and information to generate geographically localized data and information. FIG. 10 represents a flowchart 1000 depicting the steps for determining geographically localized data according to one or more embodiments of the present invention. It should be appreciated that the steps of flowchart 1000 can be modified, rearranged, and/or omitted according to the specific implementation of the present invention, and any step can be carried out by a user, a computer or in combination according to the particular implementation of the present invention.

Step 1002 is directed at receiving client sales by ZIP Code or the number of customers of a client by ZIP Code. The client may supply either sales or customers by ZIP Code. The ZIP Code data and information may be arranged and supplied in the form of a client ZIP Code file having a number of ZIP Code entries.

Step 1004 is directed at matching the client ZIP Code file with a ZIP Code master file. If a ZIP Code in the client ZIP Code file does not match with a ZIP Code in the ZIP Code master file, then such ZIP Code may be dropped from the client ZIP Code file after further investigation. The matching step generates a matched client ZIP Code file, which is used in later steps of the process of determining geographically localized data.

Step 1006 is directed at performing lifestyle cluster analysis to obtain lifestyle cluster data for each ZIP Code in the matched client ZIP Code file. According to one embodiment, the PRIZM_{NE} data available from Claritas Inc. of San Diego, Calif. is utilized to perform the lifestyle cluster analysis. The lifestyle cluster data may be representative of the characteristics and presence of a client's customers within a geographically localized area.

The following table gives an example of lifestyle cluster data for a specific ZIP Code. It should be appreciated that such data can also be generated for geographically localized areas, such as carrier routes.

TABLE 1

| Cluster | | | | | | | |
|---|---|---|---|---|---|---|---|
| Number | Cluster Name | A | B | C | D | E | F |
| 01 | Established | 302 | 2,045 | 14.77 | 0.26 | 0.16 | 159 |
| | Elite | | | | | | |
| 02 | Influential | 0 | 0 | 0 | 0 | 0 | 0 |
| | Elders | | | | | | |
| 03 | Affluent Asian | 0 | 0 | 0 | 0 | 0 | 0 |
| | Families | | | | | | |
| 04 | Town Elite | 1,839 | 14,772 | 12.45 | 1.56 | 1.16 | 134 |
| . | . | . | . | . | . | . | . |
| . | . | . | . | . | . | . | . |
| . | . | . | . | . | . | . | . |
| | Total | G | H | | | | |

The dotted rows represent that several other clusters are typically considered during this step in the analysis. Non-limiting examples of other clusters include Wealthy Singles, City Slickers, Country Grandparents and Ethnic Success.

In table 1, A represents the number of customers in each cluster. B represents the total number of cluster households in the entire market, and is otherwise referred to as the market quantity. In one or more embodiments, the entire market is defined as those geographically localized areas that include one or more client customers. C represents the number of customers divided by the market quantity, i.e., C=A/B×100. D means the percentage each cluster represents of the total customer data, i.e., D=A/G. E means the percentage each cluster represents of the entire market, i.e, E=B/H. H is defined as the total number of cluster households in all clusters of the entire market. F represents an index. The index determination includes the following steps: summing all the customers in each cluster, determining the percentage that each cluster represents of the entire customer data file, and determining the percentage each cluster represents of the total market. The determined percentages are used to determine the index for each cluster, i.e., F=D/E×100.

Step 1008 is directed at inputting ZIP Code and carrier route lifestyle cluster data based on the performed lifestyle cluster analysis.

Step 1010 is directed at calculating ZIP Code and carrier route lifestyle cluster indexes based on the lifestyle cluster data and the matched client ZIP Code file. The lifestyle cluster indexes measures the percentage of households in each cluster in the geo-unit against the index from the lifestyle analysis.

Step 1012 is directed at appending household base counts to ZIP Codes and carrier routes.

Step 1014 is directed at calculating the ZIP Code sales per household based on the matched client ZIP Code file and household base counts for each ZIP Code in the matched client ZIP Code file. Base counts refer to the number of households in a ZIP Code. Base counts may vary over a date range that may be specified for a media plan. In such case, the highest base count for the specified date range may be used. In one or more embodiments, the base counts are updated weekly. The sales per household is determined for each ZIP Code in the matched client zip file based on the sales data in the zip file divided by the base count for the applicable ZIP Code.

Step 1016 is directed at calculating estimated sales per household and estimated total sales for each carrier route. In one or more embodiments, the estimated sales per household for each carrier route is determined by multiplying the ZIP Code sales per household times the lifestyle cluster index of the carrier route, wherein the resulting value is divided by the lifestyle cluster index for the ZIP Code containing the carrier route. In one or more embodiments, the estimated total sales for each carrier code is determined by multiplying the estimated sales per household for the carrier code by the base count for the carrier code.

Table 2 depicts an example for calculating the estimated sales per household and estimated total sales for a number of carrier routes according to one or more embodiments.

TABLE 2

| Carrier | ZIP | | | | | | |
|---|---|---|---|---|---|---|---|
| Code | Code | A | B | C | D | E | F |
| 01013C006 | 01013 | $155.66 | 465 | $0.33 | 118.56 | 118.89 | $0.34 |
| 01013C007 | 01013 | $126.49 | 373 | $0.34 | 120.11 | 118.89 | $0.34 |
| 01013C008 | 01013 | $151.30 | 452 | $0.33 | 118.56 | 118.89 | $0.34 |
| 01013C009 | 01013 | $197.50 | 590 | $0.33 | 118.56 | 118.89 | $0.34 |
| 01013C010 | 01013 | $96.12 | 320 | $0.30 | 106.39 | 118.89 | $0.34 |
| 01013C011 | 01013 | $189.37 | 566 | $0.33 | 118.50 | 118.89 | $0.34 |
| 01013C021 | 01013 | $146.50 | 432 | $0.34 | 120.11 | 118.89 | $0.34 |
| 01013C053 | 01013 | $163.80 | 483 | $0.34 | 120.11 | 118.89 | $0.34 |
| 01013C056 | 01013 | $112.47 | 336 | $0.33 | 118.56 | 118.89 | $0.34 |
| 01020C020 | 01020 | $81.24 | 297 | $0.27 | 120.11 | 118.22 | $0.27 |
| 01020C022 | 01020 | $100.43 | 408 | $0.25 | 108.09 | 118.22 | $0.27 |
| 01020C023 | 01020 | $110.78 | 405 | $0.27 | 120.11 | 118.22 | $0.27 |
| 01020C024 | 01020 | $102.30 | 374 | $0.27 | 120.11 | 118.22 | $0.27 |
| 01020C025 | 01020 | $106.13 | 388 | $0.27 | 120.11 | 118.22 | $0.27 |

In the table 2, B refers to the household base count on a carrier route level. D refers to the lifestyle cluster index of each carrier route. E refers to the lifestyle cluster index of each ZIP Code. F refers to ZIP Code sales per household. C refers to the carrier route sales per household, determined by the zip sales per household (F) times the lifestyle cluster index of each carrier route (D) divided by the lifestyle cluster index of each ZIP Code (E). A refers to carrier route estimated sales, determined by carrier route sales per household (C) times base household count on a carrier route level (B). Thus, column A represents the estimated sales on a carrier route level.

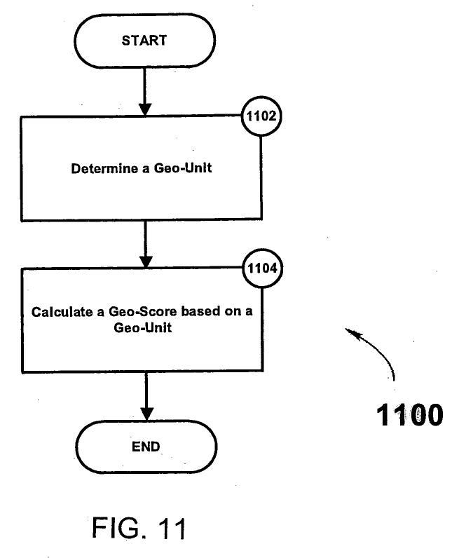

Targeting module 206 is also configured to determine geo-scores. FIG. 11 represents a flowchart 1100 depicting the steps for determining a geo-score according to one or more embodiments of the present invention. It should be appreciated that the steps of flowchart 1100 can be modified, rearranged, and/or omitted according to the specific implementation of the present invention, and any step can be carried out by a user, a computer or in combination according to the particular implementation of the present invention.

Step 1102 is directed at determining a geo-unit, which is a unit of geography. Non-limiting examples of geo-units include carrier routes, advertising targeting zones (“ATZs”) and ZIP Codes. In one or more embodiments, an ATZ is a number of carrier codes within a single ZIP Code. In one or more embodiments, the analytical platform for determining ATZs is a cluster analysis applied to all carrier routes within a ZIP Code to optimize the configuration of the carrier routes into clusters while satisfying three constraints. The three constraints are size, shape and a number of socio-demographic dimensions. The size goal is approximately 3500 households per ATZ. The shape goal is to maximize the number of coterminous touch points at the turns of a shape of the outside boundary of adjacent ATZs such that the creation of strings is avoided or minimized. A non-limiting example of a string is the lake front on Lake Shore Drive in Chicago, Ill., which could yield an ATZ that is one carrier route wide by thirty blocks long. In one embodiment, the number of socio-demographic dimensions includes four socio-demographic dimensions of age, income, household size and ethnicity. The goal is for households within an ATZ to share similar characteristics that can serve to differentiate one ATZ from another. As such, the ATZ may be marketed differently than a ZIP Code would be as a whole.

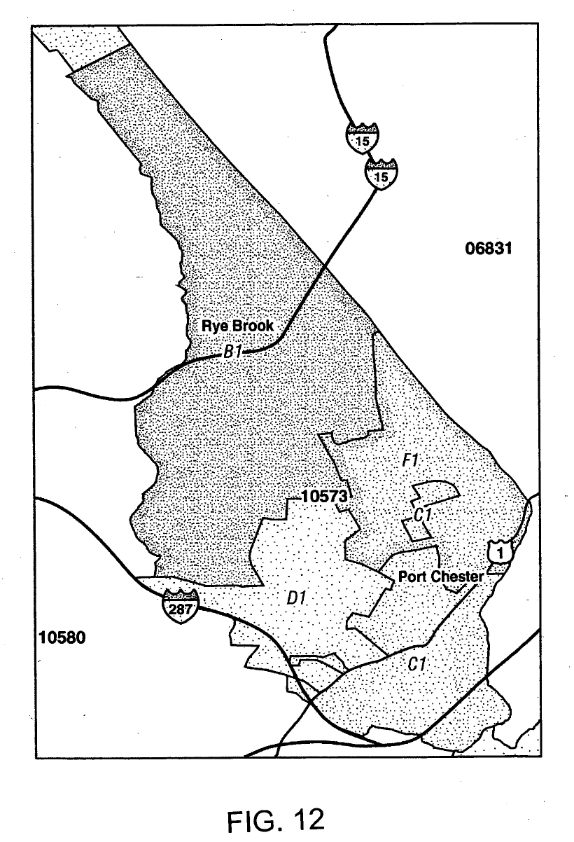

FIG. 12 depicts an example of different geo-units, such as, ZIP Codes and ATZs. The region bounded by the thick line and identified as 10573 is an example of a ZIP Code. The regions identified as B1, C1, D1 and F1 are examples of ATZs. It should be appreciated that each ATZ in this example is made up of a number of carrier routes.

Turning back to FIG. 11, Step 1104 is directed at calculating a geo-score based on a geo-unit. According to one embodiment, a number of geo-unit types are identified and then the specific geo-unit is matched with the most appropriate geo-unit type. In one or more embodiments, this matching is based on availability of data and which data prove most predictive. Non-limiting examples of data that may be available include PRIZM_{NE} variables from Claritas Inc. of San Diego, Calif.; demographic/census data; and newspaper variable data. The most appropriate geo-unit type correlates to a function for calculating the geo-score. The following table identifies the correlation across rows of the table according to one embodiment.

TABLE 3

| Type | Description | Function |
|---|---|---|
| A₁ | In or out of trade | In/Out |
| | area | |
| A₂ | Distance from a site | Distance Scaling Factor |
| B₁ | Demographic | Composite Demographic Index |
| | characteristics | |
| B₂ | Demographics and | (Composite Demographic Index) * (Distance |
| | distance | Scaling Factor) |
| C | Sales | Average Sales per Household |
| D | Customer behavior | Index Value of Behavioral Variable |
| E | Historical data of | Index Value Of Response |
| | media promotion | |
| | responses | |
| α | Custom | Custom Function |

In one or more embodiments, the function associated with type A₁ is value=1 if within the applicable trade area, or value=0 if outside the applicable trade area. In one or more embodiments, the Distance Scaling Factor associated with type A₂ is value=dᵢ, where d is a distance measure in either miles or minutes of drive time from site i. In one or more embodiments, the Composite Demographic Index associated with type B₁ is represented by the following equation:

value=(v₁w₁+v₂w₂+ . . . +vₙwₙ) (1)

In equation 1, vⱼ is the value of variable j. wⱼ is the weight of variable j. Each wⱼ is required to be a whole number and the following equation must also be satisfied:

$${\sum }_{j = 1}^{n} {w}_{j} = 100 \qquad ( 2 )$$

In one or more embodiments, the function associated with type B₂ is the multiplicative of the above-identified Composite Demographic Index and Distance Scaling Factor. In one or more embodiments, the Average Sales per Household associated with type C is value=sᵢ/hᵢ, where sᵢ equals sales and hi equals the number of households. In one or more embodiments, the Index Value of Behavioral Variable associated with type D is a variation of the type B₁ functional relationship identified above. The value of type B₁ is transformed so that the μ=100 and 10 points on a scale represents a 10% increase in propensity. For example, a score of 130 indicates that the group represented by the score is 30% more likely than average to demonstrate a behavior, such as shopping for a particular brand. In one or more embodiments, a score between 80 and 120 are considered insignificantly different from average. In one or more embodiments, the Index Value of Response associated with type E is a form of the Index Value of Behavioral Variable as identified above.

In one or more embodiments, the Composite Demographic Index refers to a number that combines unlike targeting variables. The Composite Demographic Index may be determined using the Crossbow Web software product available from Crossbow Media Inc. of Rye, N.Y. The Composite Demographic Index is further described through the following example. A pizza client may know that their customers have the following demographics: households with children and income of $40,000+. It may also be important to factor in the variable that measures an individual's potential to go to fast food pizza places. A weight is applied to each variable, i.e., children, income and potential, such that the sum of the weights is 100.

Non-limiting examples of sites include stores, restaurants, cell phone areas and home addresses. Non-limiting examples of customer behavior variable sets include consumer buying power, CREST, MRI and Scarborough. Variables in the consumer buying power variable set include spending power, jewelry and food away from home. The CREST variable set includes consumer purchase data of commercially prepared foods. The MRI variable set includes consumer behavior survey data, such as crafts, gardening, dog ownership and sports watching. The MRI variable set is available from Media Research, Inc. of New York, N.Y. The Scarborough variable set includes media and product usage survey data.

In one or more embodiments, a custom function can be selected under Type a using one or more of the above-identified types.

### V. MAA Module

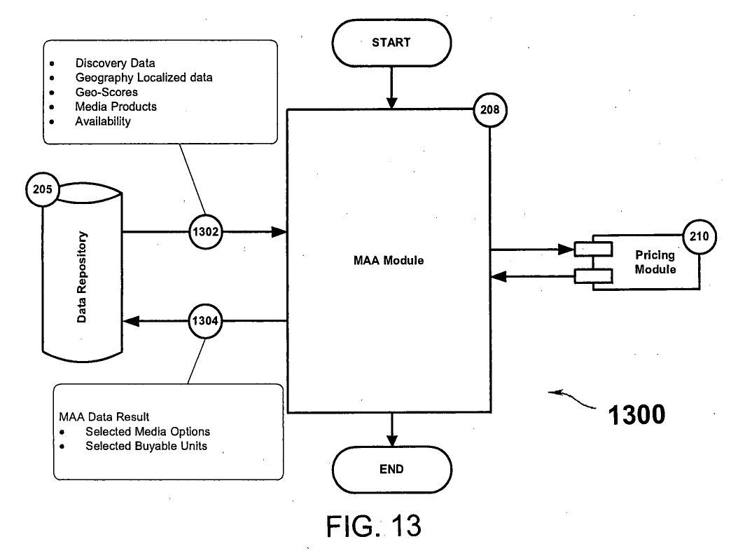

FIG. 13 depicts a process map 1300 relating to MAA module 208 according to one or more embodiments of the present invention. MAA module 208 receives data and information from various sources. For example, MAA module 208 may receive data and information, such as discovery data and information, output from the discovery module 202 and data and information, such as geographically localized data and HVSs, output from the targeting module 206, as generally depicted by arrow 1302. Other data and information may be received by the MAA module 208, such as data and information relating to media products and their availability. Such data and information may reside on a media inventory within data repository 205.

MAA module 208 may receive media product pricing data and information from pricing module 210. Such media product pricing data and information may reside on an HB media computer system or an ERP computer system, which may be part of data repository 205. MAA module 208 is configured to transmit data and information relating to selected media options and selected media buyable units, as depicted by arrow 1304.

MAA module 208 may be configured to calculate a household value score (HVS) of a geo-unit based on the household count in the geo-unit and the geo-score of the geo-unit. In one or more embodiments, the HVS is a number representing the relative value to a media campaign of reaching the geo-unit being examined. The HVS value is computed based on a function only of the geo-unit and is therefore independent of the media product. If the geo-score is a direct measurement or a count, then the HVS is the geo-score. If the geo-score is expressed as an index, over all households in the geo-unit, then the HVS is the geo-score times the household count.

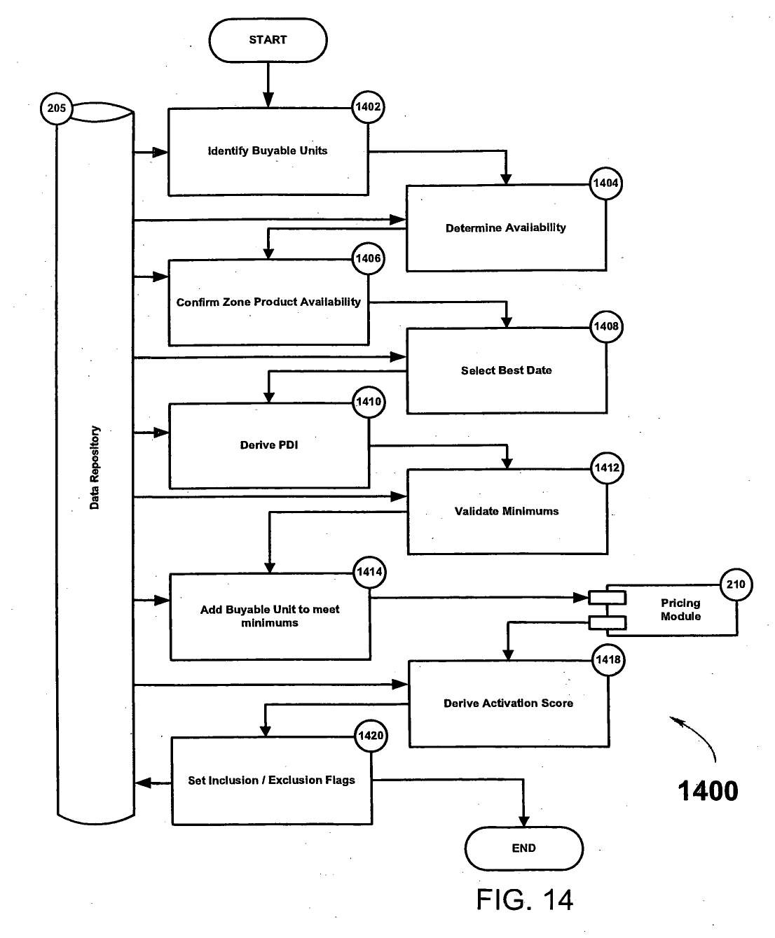

FIG. 14 depicts a flowchart 1400 of steps that are executed by MAA module 208 according to one or more embodiments. It should be appreciated that the steps of flowchart 1400 can be modified, rearranged, and/or omitted according to the specific implementation of the present invention, and any step can be carried out by a user, a computer or in combination according to the particular implementation of the present invention.

According to block 1402, MBUs are identified. In one or more embodiments, an MBU is the lowest level of a media option that can be purchased by a client that covers a geographic area. A non-limiting example of an MBU is a newspaper insert in one or more ZIP Codes, which may make up a zone called “cluster 87” in the Boston Globe Sunday edition. An MBU for shared mail inserts may be a ZIP Code or ATZ. An MBU for solo mail inserts may be a postal carrier route. An MBU for a REDPLUM wrap may be a wrap zone. An MBU for a ZIC may be a ZIC zone. An MBU for an ROP may be the full run of a single newspaper. An MBU for a cooperative free standing insert may be a grouping of multiple delivery vehicles.

It should be appreciated that other MBUs are contemplated by one or more embodiments of the present invention. For example, a household may be a media buyable unit for one or more media product options contemplated by one or more embodiments. As another non-limiting example, an individual within a household may be an MBU.

MAA module 208 is configured to identify all buyable parents of a targeted carrier route. For each media product selected by a client during execution of discovery module 202, MAA module 208 retrieves all MBUs containing at least one targeted carrier route. If an exclusion file is stored in data repository 205, MAA module 208 is configured to reject MBUs associated with the media number and edition provided in the exclusion file.

According to block 1404 of FIG. 14, the availability of the media options associated with the MBUs is identified in block 1402. In one or more embodiments, media options refer to the distribution of media products associated with each MBU. In one or more embodiments, newspaper media products are defined on the edition level, and direct mail media products are defined at the direct mail distribution level. This step may also include eliminating any media products if such media products are not available within the client's requested date range.

According to block 1406, the inventory availability of zone media products, such as REDPLUM wrap and ZIC media products, is confirmed. In one or more embodiments, the exclusivity of REDPLUM wrap media products is also checked during this step.

According to block 1408, the available media options are de-duplicated by selecting the media product with the best date according to client preferences and business rules. The business rules may include in-home date and the client preferences may include before or after in-home date preferences stored in data repository 205 during execution of discovery module 202. It should be appreciated that in-home date refers to the date on which the particular media reaches the home. The delivery date is the in-home date for newspapers. A two day window is typically given as an in-home date range for media delivered by mail.

The best date may be selected according to the following prioritization: (1) client's preferred date; (2) best food day or direct mail package in-home date, and the day meets the client's directional preference of before or after the in-home date preference; (3) non-best food day and the day meets the client's directional preference; (4) best food day or direct mail package in-home date and the day does not meet the client's directional preference; and (5) non-best food day and the day does not meet the client's directional preference. In one or more embodiments, the best food day is the best day of the week for food purchases according to a number of grocers within a defined market.

According to block 1410, the PDI value is calculated. In one or more embodiments, PDI represents the conformance of the media option distribution date to the client's date preferences. In one embodiment, the PDI value ranges from 1.0 to 0.82, with the value decreasing relative to the alignment of the media option to the client's expressed date preferences.

According to block 1412, newspaper minimum buys for media products having pre-preprinted material, such as newspaper inserts, are validated. First, a number of available buyable units associated with a newspaper or edition are selected. The total circulation or purchase represented by the selected buyable units is determined. If the total circulation or purchase is within 90% (or some other defined percentage) of the minimum amount for the associated newspaper or edition, the selected buyable units are maintained. If the total circulation or purchase is less than 75% (or some other defined percentage) of the minimum amount, the number of selected buyable units associated with the newspaper or edition is removed from the list of available buyable units. If the total circulation or purchase is 75% (or some other defined percentage) or greater than the minimum amount, but less than 90% (or some other defined percentage) of the minimum amount, then available buyable units are added to the number of selected buyable units, as depicted in block 1414. In one embodiment, all available buyable units within a radius, such as a 5 mile radius, of the selected buyable units are identified. The identified buyable units are added to the selected buyable units to reach the required minimum of 90%. The radius may be expanded in order to meet the required minimum.

According to block 1416, pricing data is derived for all media options not explicitly excluded by the client. The pricing data is utilized by optimization module 212 so that optimized media plans are within budget constraints specified during execution of discovery module 202.

According to block 1418, an activation score is determined by MAA module 208. In one or more embodiments, an activation score means a relative score representing the value of a particular media product in relation to another media product in terms of the effectiveness in achieving a client's objectives. The activation score captures the level to which a media option achieves client objectives and household engagement with the selected media option. The activation score is a function of the particular media vehicle and is independent of geography.

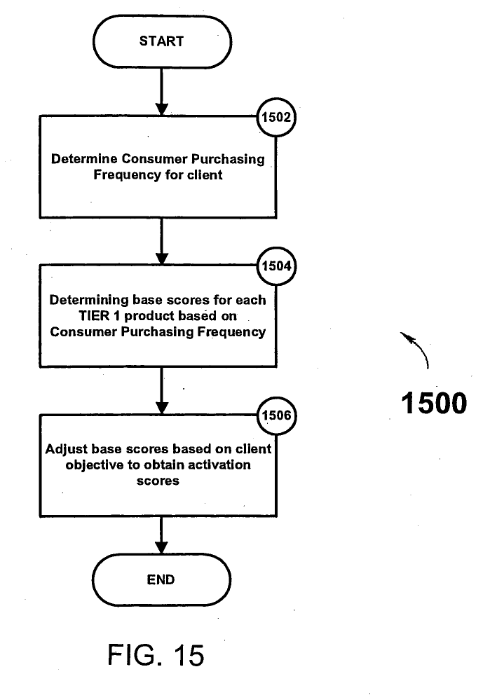

FIG. 15 represents a flowchart 1500 depicting the steps for determining an activation score according to one or more embodiments of the present invention. It should be appreciated that the steps of flowchart 1500 can be modified, rearranged, and/or omitted according to the specific implementation of the present invention, and any step can be carried out by a user, a computer or in combination according to the particular implementation of the present invention.

Step 1502 is directed at determining a consumer purchasing frequency for a client. Non-limiting examples of consumer purchasing frequencies include ritual, reminder, research and consumer packaged goods (CPG). In one or more embodiments, the ritual consumer purchasing frequency includes those retailers who sell goods and/or services that a consumer may utilize relatively often, such as numerous times per month, without giving much thought to their specific choice of such goods and/or services. Non-limiting examples of clients, i.e., retailers, which may fall into the ritual consumer purchasing frequency include dry cleaners, grocery stores, packaged goods retailers, quick service restaurants and video stores. In one or more embodiments, the reminder consumer purchasing frequency includes those retailers who sell goods and/or services that a consumer may utilize periodically, although with a relative low frequency. Non-limiting examples of retailers that may fall into the reminder consumer purchasing frequency include auto services, carpet cleaning, optical stores, fine dining, healthcare, home services, professional services, specialty stores, sports and leisure and tires. In one or more embodiments, the research consumer purchasing frequency includes those retailers who sell good and/or services that a consumer will likely choose to research in advance of their purchase. Non-limiting examples of retailers that may fall into the research consumer purchasing frequency include auto dealers and manufacturers, consumer electronics retailers, department stores, financial services, home furnishings, home improvement stores, home remodeling business, mattress and bedding stores, real estate, satellite, soft goods, telecommunications and travel. In one or more embodiments, the CPG consumer purchasing frequency includes those retailers that sell goods that are consumable and need frequent replacement, such as food, beverages, and cleaning products.

Step 1504 is directed at determining base scores for each tier one product based on the applicable consumer purchasing frequency. In one embodiment, the base score data for the ritual, reminder and research frequencies are obtained from BIGresearch, LLC of Worthington, Ohio and the base score data for the CPG consumer purchasing frequency is obtained from NCH Marketing Services Ltd. of the United Kingdom. In one embodiment, the base scores for each tier product is an average of a number of base scores for each individual retailer within the applicable consumer purchasing frequency.

Step 1506 is directed at adjusting base scores based on client objective. In one embodiment, the client objective is selected from a number of client objectives, including conversion, retention, awareness, acquisition, frequency or ticket. In one embodiment, the conversion objective focuses on increasing share of a current customer spending by taking such a share away from the competitor. In one embodiment, the retention objective focuses on maintaining current customers and their current spending. In one embodiment, the awareness objective focuses on increasing “top of mind” position, such as the top three amongst all competition in that industry's accepted competitive frame. In one embodiment, the acquisition objective focuses on acquiring new loyal customers. In one embodiment, the frequency objective focuses on increasing frequency of purchases. In one embodiment, the ticket objective focuses on total spend per transaction.

In one embodiment, a two dimension matrix of the client objectives and the consumer purchasing frequency is constructed to obtain a table of rating of the relative effectiveness of individual media vehicles for each of the client objectives. Such tables can be constructed for each of the consumer purchasing frequency, such as ritual, reminder, response and CPG.

Table 4, which is set forth below, depicts the two dimensional matrix for the ritual consumer purchasing frequency according to one embodiment. The i of β_{i,j} is the client objective and j of β_{i,j} is the media product. β is selected from the group high, medium and low depending on market and/or client data and information.

TABLE 4

| | | | Preprint | | | |
|---|---|---|---|---|---|---|
| | Solo | Preprint | Shared | | | |
| | Saturation | Newspaper | Mail | Wrap | FSI | ROP |
| Conversion | β_{i,j} | β_{i,j} | β_{i,j} | β_{i,j} | β_{i,j} | β_{i,j} |
| Retention | β_{i,j} | β_{i,j} | β_{i,j} | β_{i,j} | β_{i,j} | β_{i,j} |
| Awareness | β_{i,j} | β_{i,j} | β_{i,j} | β_{i,j} | β_{i,j} | β_{i,j} |
| Acquisition | β_{i,j} | β_{i,j} | β_{i,j} | β_{i,j} | β_{i,j} | β_{i,j} |
| Frequency | β_{i,j} | β_{i,j} | β_{i,j} | β_{i,j} | β_{i,j} | β_{i,j} |
| Ticket | β_{i,j} | β_{i,j} | β_{i,j} | β_{i,j} | β_{i,j} | β_{i,j} |

Table 5, which is set forth below, depicts the two dimensional matrix for reminder consumer purchasing frequency according to one embodiment. The i of β_{i,j} is the client objective and j of β_{i,j} is the media product. β is selected from the group high, medium and low depending on market and/or client data and information.

TABLE 5

| | | | Preprint | | | |
|---|---|---|---|---|---|---|
| | Solo | Preprint | Shared | | | |
| | Saturation | Newspaper | Mail | Wrap | FSI | ROP |
| Conversion | β_{i,j} | β_{i,j} | β_{i,j} | β_{i,j} | β_{i,j} | β_{i,j} |
| Retention | β_{i,j} | β_{i,j} | β_{i,j} | β_{i,j} | β_{i,j} | β_{i,j} |
| Awareness | β_{i,j} | β_{i,j} | β_{i,j} | β_{i,j} | β_{i,j} | β_{i,j} |
| Acquisition | β_{i,j} | β_{i,j} | β_{i,j} | β_{i,j} | β_{i,j} | β_{i,j} |
| Frequency | β_{i,j} | β_{i,j} | β_{i,j} | β_{i,j} | β_{i,j} | β_{i,j} |
| Ticket | β_{i,j} | β_{i,j} | β_{i,j} | β_{i,j} | β_{i,j} | β_{i,j} |

Table 6, which is set forth below, depicts the two dimensional matrix for research consumer purchasing frequency according to one embodiment. The i of β_{i,j} is the client objective and j of β_{i,j} is the media product. β is selected from the group high, medium and low depending on market and/or client data and information.

TABLE 6

| | | | Preprint | | | |
|---|---|---|---|---|---|---|
| | Solo | Preprint | Shared | | | |
| | Saturation | Newspaper | Mail | Wrap | FSI | ROP |
| Conversion | β_{i,j} | β_{i,j} | β_{i,j} | β_{i,j} | β_{i,j} | β_{i,j} |
| Retention | β_{i,j} | β_{i,j} | β_{i,j} | β_{i,j} | β_{i,j} | β_{i,j} |
| Awareness | β_{i,j} | β_{i,j} | β_{i,j} | β_{i,j} | β_{i,j} | β_{i,j} |
| Acquisition | β_{i,j} | β_{i,j} | β_{i,j} | β_{i,j} | β_{i,j} | β_{i,j} |
| Frequency | β_{i,j} | β_{i,j} | β_{i,j} | β_{i,j} | β_{i,j} | β_{i,j} |
| Ticket | β_{i,j} | β_{i,j} | β_{i,j} | β_{i,j} | β_{i,j} | β_{i,j} |

Table 7, which is set forth below, depicts the two dimensional matrix for the CPG consumer purchasing frequency according to one embodiment. The i of β_{i,j} is the client objective and j of β_{i,j} is the media product. β is selected from the group high, medium and low depending on market and/or client data and information.

TABLE 7

| | | | Preprint | | | |
|---|---|---|---|---|---|---|
| | Solo | Preprint | Shared | | | |
| | Saturation | Newspaper | Mail | Wrap | FSI | ROP |
| Conversion | β_{i,j} | β_{i,j} | β_{i,j} | β_{i,j} | β_{i,j} | β_{i,j} |
| Retention | β_{i,j} | β_{i,j} | β_{i,j} | β_{i,j} | β_{i,j} | β_{i,j} |
| Awareness | β_{i,j} | β_{i,j} | β_{i,j} | β_{i,j} | β_{i,j} | β_{i,j} |
| Acquisition | β_{i,j} | β_{i,j} | β_{i,j} | β_{i,j} | β_{i,j} | β_{i,j} |
| Frequency | β_{i,j} | β_{i,j} | β_{i,j} | β_{i,j} | β_{i,j} | β_{i,j} |
| Ticket | β_{i,j} | β_{i,j} | β_{i,j} | β_{i,j} | β_{i,j} | β_{i,j} |

In one embodiment, a multiplier is associated with the high, medium and low ratings. In one embodiment, the multipliers for high, medium and low are 1.25, 1.0 and 0.85, although in other embodiments, these multipliers can be adjusted based on empirical data. With respect to each tier one product, the activation score is obtained by multiplying the base score and the multiplier.

Having described the determination of activation scores according to FIG. 15, the following provides an example of such a determination with values. Company X may desire a media plan for a back to school event with the client objective of Ticket. The Ticket objective may be most applicable because Company X may want to upsell existing customers. Company X is considered to fall in the ritual industry category. The base activation scores are obtained through market research and are averaged over a product category. The activation scores are represented as percentages with a value of between 0 and 1. The activation scores typically change over time, and are subject to periodic updates, such as monthly updates. The base activation scores for this example are set forth in the table below.

TABLE 8

| Media Product | Ritual Base Scores |
|---|---|
| Solo Saturation | 0.5 |
| Preprint in Newspaper | 0.8 |
| Preprint in Shared Mail | 0.9 |
| ShopWise Wrap | 1.0 |
| FSI | 1.0 |
| ROP | 0.7 |

As the next step in the process, the ritual base scores may be adjusted based on the client objective to obtain the activation scores. The following table depicts the performance ratings for each tier one product for the ticket objective according to one embodiment.

TABLE 9

| Media Product | Ticket Performance |
|---|---|
| Solo Saturation | Low |
| Preprint in Newspaper | High |
| Preprint in Shared Mail | High |
| ShopWise Wrap | High |
| FSI | High |
| ROP | Medium |

For purposes of this example, the multipliers of 1.25, 1.0, and 0.85 were utilized for high, medium and low. As such, the following table shows the calculation of the adjusted activation score for each media product with tier one.

TABLE 10

| | Base | | Activation |
|---|---|---|---|
| Media Product | Score | Multiplier | Score |
| Solo Saturation | 0.5 | 0.85 | 0.425 |
| Preprint in | 0.8 | 1.25 | 1.0 |
| Newspaper | | | |
| Preprint in Shared | 0.9 | 1.25 | 1.125 |
| Mail | | | |
| ShopWise Wrap | 1.0 | 1.25 | 1.25 |
| FSI | 1.0 | 1.25 | 1.25 |
| ROP | 0.7 | 1.0 | 0.7 |

In one or more embodiments, the HVS and activation score are factors used in determining a media buyable unit (“MBU”) score. Other factors are also used in the determination of an MBU score. For example, penetration, otherwise referred to as coverage, is the ratio of the number of media option units distributed and/or sold across a MBU's media footprint comprised of a number of geo-units to the number of base count households in the number of geo-units that constitute the media footprint. Equation 3 depicts penetration in algebraic terms.

$$Penetration = \frac{Circulation}{Total HHs} \qquad ( 3 )$$

Another factor considered in the MBU score determination is preferred date index (“PD” or “PDI”). In one or more embodiments, PDI means a scaling factor (multiplier) that captures how close a MBU's delivery date is to the client's preferred delivery date, assuming one has been specified. If the media option falls on the client's preferred in-home date, or no preferred date has been specified, then PDI equals 1. Otherwise, the PDI value is less than 1, decreasing for dates that are further away from the client's preferred date. In at least one embodiment, the PDI value is based on client preference, and may change over time.

Having thus defined the factors used in determining an MBU score, the following equation 4 depicts an algebraic relationship between activation, penetration and effective coverage according to one embodiment.

APEC(MBUᵢ)=Activation(MBUᵢ)×Penetration(MBUᵢ)×PD(MBUᵢ)ΣⱼHVS(GUⱼ) (4)

This equation is referred to as the APEC equation, which measures the value of each MBU considering all the geounits its touches. This value is otherwise referred to as the APEC score. In one or more embodiments, the APEC score captures the level to which a media option achieves the client's objectives and household engagement with the media option. The APEC score is determined by multiplying an MBU's activation score times its penetration times its PD times the sum of the HVSs for the geo-units touched by the MBU.

For each MBU within a particular geo-unit, the MBU score may be calculated using the following equation 5:

$$MBU Score = \frac{APEC}{Sell Price} \qquad ( 5 )$$

In one or more embodiments, the sell price refers to the cost associated with purchasing the media buyable unit with the particular geo-unit. For example, the sell price for a ZIC may be a wrap zone. As another example, the sell price for a newspaper insert may be a newspaper zone.

According to block 1420 of FIG. 14, an inclusion/exclusion flag associated with each available media product for each of a number of recommended media plans is set based on client preferences and business rules. In one embodiment, the number of recommended media plans includes three recommended media plans referred to as a client preferences recommendation, a full portfolio recommendation and a flexed client preference recommendation.

### VI. Optimization Module

The MBU score is a relative score for a certain MBU as compared across a number of MBUs. Optimization module 212 utilizes the MBU scores to compare possible media product purchases based on a combination of factors and selects those MBUs that are most desirable to a client's objectives. In one or more embodiments, the optimization module 212 requires that metrics used in the optimization algorithm are multiplicative. For example, the difference between 4 and 1 is 4 times the difference between 2 and 1. A value of interest can often be restated as a metric that has the multiplicative quality.

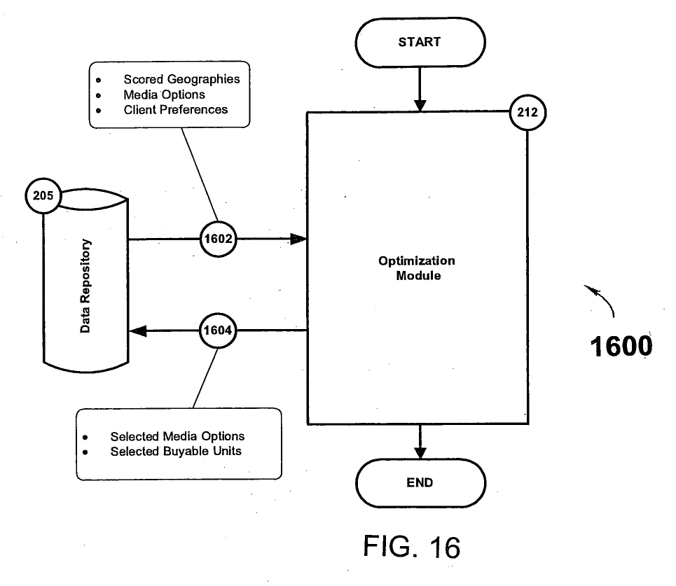

FIG. 16 depicts a process map 1600 relating to optimization module 212 according to one or more embodiments of the present invention. Optimization module 212 receives data and information generated by MAA module 210 and stored in data repository 205. Such data and information includes, but is not limited to, geo-unit data and information, MBU data and information, constraint data and information, and client preference information, as generally depicted by arrow 1602. Geo-unit data and information includes, without limitation, geo-unit identifications, household counts and geo-scores. MBU data and information includes, but is not limited to, MBU identifications, media product definitions, media product footprints, media product editions, media numbers, delivery types, sell prices, penetration in footprint, PDIs and activation scores. Constraint information includes, without limitation, applicable minimum volumes for certain media products, required geo-units according to client's preferences and client budget. Client budget constraint information may include a total client budget, required market allocation budgets, and required store allocation budgets. Required geo-units may include information for required MBUs to cover a specific geography, such as home zips and/or other geo-units. In one or more embodiments, constraint information may also include newspaper groups for ROPs, saturation products limitations and penetration constraints. A non-limiting example of a saturation product limitation is a rule against the selection of two different saturation products covering the same geo-unit. Non-limiting examples of penetration constraints include (1) avoid total penetration beyond 100% for any given geo-unit and (2) avoid total newspaper penetration beyond 65% for any geo-unit.

Optimization module 212 is configured to select a number of MBUs to obtain an optimized media plan for each of a number of scenarios. In one embodiment, three scenarios are considered, namely, client preferences (scenario 1), full portfolio (scenario 2), and flexed client preferences (scenario 3). In one embodiment, a client's page position preference submitted during execution of discovery module 202 is utilized with scenarios 1 and 2. The lowest cost option page position (e.g., inside cover) is typically used for scenario 3.

In one or more embodiments, an objective function is utilized to execute the optimization process. One such objective function takes the form of equation 6 reproduced below:

$$Objective Function = {\sum }_{i} APEC ( {MBU}_{i} ) \times {x}_{i} - {\sum }_{j} ( {λ}_{j} {y}_{i} + {ρ}_{j} {z}_{j} ) \qquad ( 6 )$$

The first term of the objective function is equal to the total APEC value associated with the selected MBUs. The second term of the objective function is equal to the penalties for geo-unit penetration that is considered too high, as defined by the client or other sources.

According to one optimization algorithm, the objective function is maximized such that the resulting optimized media plan includes as much APEC value as possible while minimizing the penalties by avoiding geo-unit penetration that is too high and satisfying client objectives and constraints, such as required geo-units and budgets.

xᵢ is a decision variable, i.e. 0 or 1, that determines whether or not a particular MBUᵢ is included in the optimized media plan. In one or more embodiments, the optimization algorithm assigns values to xᵢ that make the value of the objective function as large as possible while satisfying all constraints being considered.

The second term of the objective function guides the optimization algorithm away from undesirable behavior, such as duplicating coverage of highly attractive geo-units. λⱼ is the penalty associate with cumulative penetration above a certain percentage for geo-unit j. In one embodiment, the certain percentage is 100%, while it should be appreciated that in other embodiments, the percentage may be lower or higher. The value of λⱼ is the HVS of geo-unit j times the smallest activation score out of all the MBUs that touch the geo-unit j. ρⱼ is the penalty associated with cumulative newspaper penetration above a certain percentage for geo-unit j. In one embodiment, the certain percentage is 100%, while it should be appreciated that in other embodiments, the percentage may be lower or higher. The value of ρⱼ is the HVS of geo-unit j times the smallest activation score out of all MBUs that touch geo-unit j. yⱼ is the cumulative penetration above a certain percentage due to mail for geo-unit j. In one embodiment, the certain percentage is 100% because the penetration goal is typically 100% for mail, while it should be appreciated that in other embodiments, the percentage may be lower or higher. x_{z} is the cumulative penetration above a certain percentage due to newspaper coverage for geo-unit j. In one embodiment, the certain percentage is 65% because the penetration goal is typically 65% for newspapers, while it should be appreciated that in other embodiments, the percentage may be lower or higher.

In one or more embodiments, optimization module 212 is configured to use a greedy-type algorithm with the objective function in order to obtain optimized media plans. The greedy-type algorithm looks at all available MBUs and picks the one with the biggest relative marketing value per client dollar spent. After picking one MBU, the greedy-type algorithm considers the remaining MBUs and selects the next best one in terms of marketing value per client dollar spent. The greedy-type algorithm also checks constraints as it selects MBUs to ensure that they will be satisfied.

In other embodiments, optimization module 212 may be configured to use other algorithms with the objective function in order to obtain optimized media plans. Non-limiting examples of other algorithms include Any algorithy used to solve mixed integer problems.

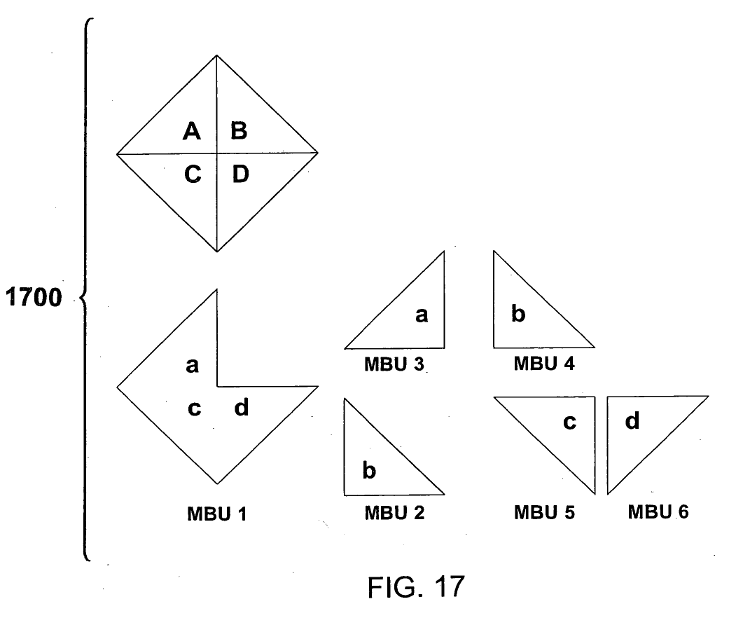

FIG. 17 depicts a schematic diagram illustrating the use of a greedy-type algorithm to obtain an optimized media plan. According to the client's objectives and constraints, four geo-units A, B, C and D are to be covered by a media plan footprint with a $10 budget. As depicted in FIG. 17, the optimization algorithm can select from six MBUs, i.e., MBU1, MBU2, MBU3, MBU4, MBU5 and MBU6, in order to satisfy the client's objectives and constraints. Table 11 lists the value, cost and value per cost for each MBU.

TABLE 11

| MBU | Value | Cost | Value/Cost |
|---|---|---|---|
| MBU1 | 100 | $9 | 11.1 |
| MBU2 | 1 | $1 | 1 |
| MBU3 | 33 | $3 | 11 |
| MBU4 | 33 | $3 | 11 |
| MBU5 | 44 | $4 | 11 |
| MBU6 | 50 | $4 | 10 |

The greedy-type algorithm selects the MBU with the largest value/cost while satisfying the client's objectives and constraints. Accordingly, the greedy-algorithm selects MBU1 with a value/cost of 11.1. The greedy-type algorithm then selects an MBU from the remaining MBUs with the biggest value while satisfying the client's objectives and constraints. MBU2 and MBU4 satisfy the client's objective of selecting an MBU for geo-unit B. However, MBU4 does not satisfy the client's budgetary constraint because it is $3 and only $1 remains after the selection of MBU1. As such, MBU2 is selected. Therefore, the optimized media plan using the greedy-type algorithm includes MBU1 and MBU2, with a total value of 101.

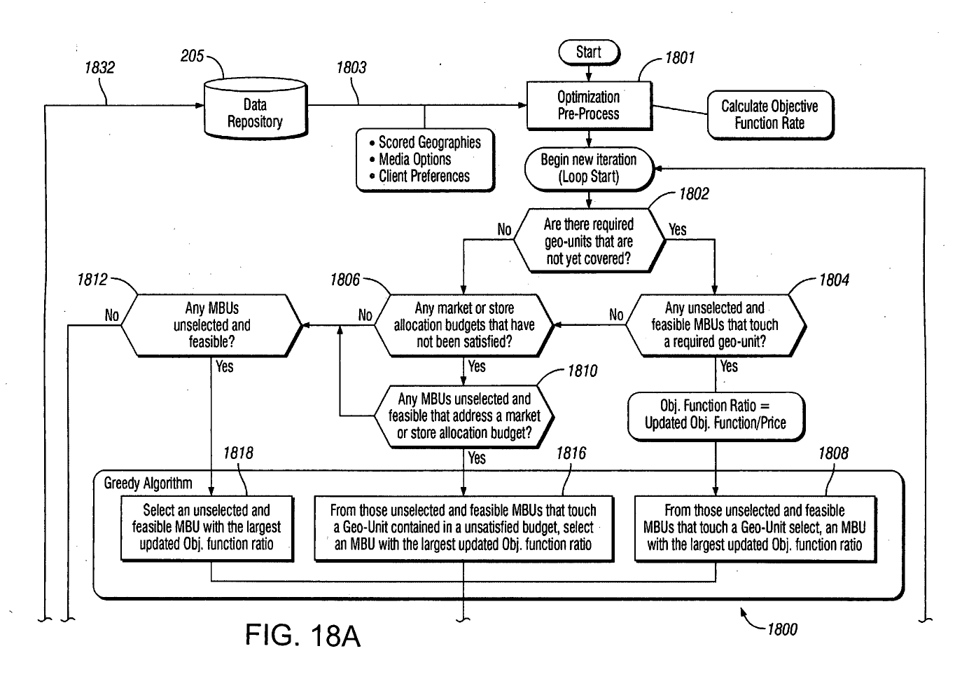

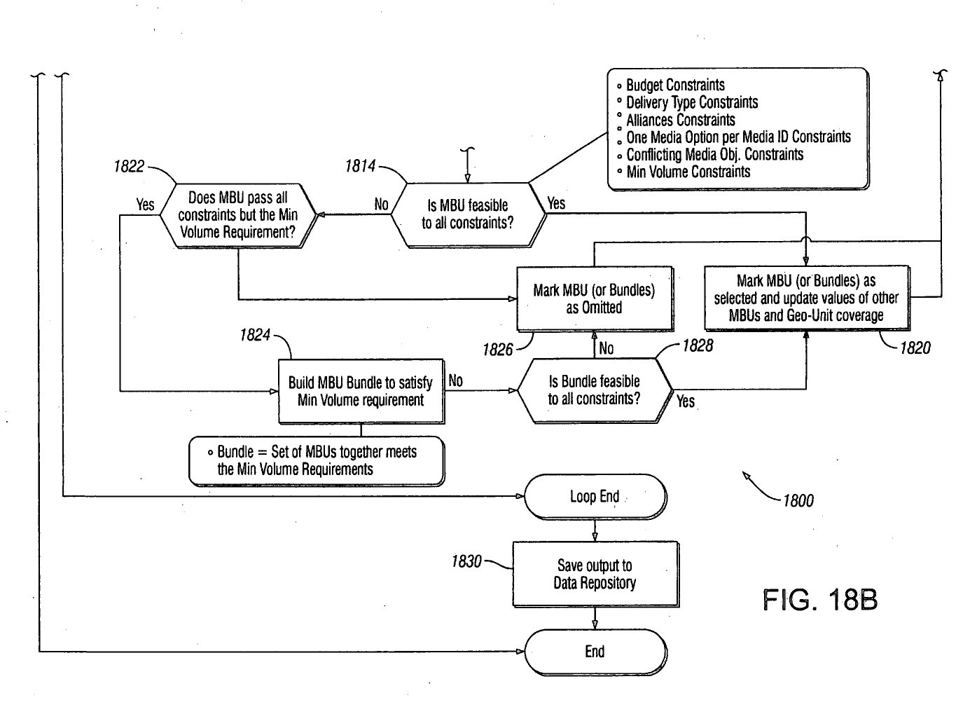

FIGS. 18A and 18B depict a flowchart 1800 for implementing a greedy-type algorithm with the objective function to obtain an optimized media plan for one of the number of scenarios. FIGS. 18A and 18B may be referred to herein collectively as FIG. 18. It should be appreciated that the steps of flowchart 1800 can be modified, rearranged, and/or omitted according to the specific implementation of the present invention, and any step can be carried out by a user, a computer or in combination according to the particular implementation of the present invention. Optimization module 212 may be configured to execute the implementation to obtain optimized media plans for each of the number of scenarios being considered.

Block 1801 carries out the optimization pre-process step to calculate rates for the objective function. The inputs for the optimization pre-process step and the greedy-type algorithm implementation may include stored geographies, media options and client preferences as depicted by arrow 1803.

Decision block 1802 questions whether there are any required geo-units that are not yet covered by the media plan. If the answer is yes, then optimization module 212 proceeds to decision block 1804. If the answer is no, then optimization module 212 proceeds to decision block 1806.

Decision block 1804 questions whether any MBUs are unselected and feasible and touch a required geo-unit. If the answer is yes, then optimization module 212 proceeds to block 1808. If the answer is no, then optimization module 212 proceeds to decision block 1806.

Block 1808 selects an unselected and feasible MBU from those MBUs that touch a required geo-unit with the largest updated objective function value to price ratio. It should be appreciated that as MBUs are selected by the greedy-type algorithm, the objective function to price ratio may be updated to reflect a change in value due to removing the selected MBUs from the analysis. After carrying out the step identified in block 1808, optimization module 212 proceeds to decision block 1814.

Decision block 1806 questions whether there are any market or store allocation budgets that have not yet been satisfied. If the answer is yes, then optimization module 212 proceeds to decision block 1810. If the answer is no, then optimization module 112 proceeds to decision block 1812.

Decision block 1810 questions whether there are any unselected and feasible MBUs address a market or store allocation budget constraint. If the answer is yes, then optimization module 212 proceeds to block 1816. If the answer is no, then optimization module 212 proceeds to decision block 1812.

Decision block 1812 questions whether there are any MBUs that are unselected and feasible. If the answer is yes, then optimization module 212 proceeds to block 1818. If the answer is no, then optimization module 212 terminates the optimization algorithm.

Block 1816 selects an unselected and feasible MBU from those MBUs that touch a geo-unit contained in a market or store region with an unsatisfied allocation budget with the largest updated objective function to price ratio. It should be appreciated that as MBUs are selected by the greedy-type algorithm, the objective function to price ratio may be updated to reflect a change in value due to removing the selected MBUs from the analysis. After carrying out the step identified in block 1808, optimization module 212 proceeds to decision block 1814.

Block 1818 selects an unselected and feasible MBU with the largest updated objective function to price ratio. It should be appreciated that as MBUs are selected by the greedy-type algorithm, the objective function to price ratio may be updated to reflect a change in value due to removing the selected MBUs from the analysis. After carrying out the step identified in block 1808, optimization module 212 proceeds to decision block 1814.

Decision block 1814 questions whether the considered MBU is feasible to all constraints being considered. If the answer is yes, then optimization module 212 proceeds to block 1820. If the answer is no, then optimization module 112 proceeds to decision block 1822.

Block 1820 marks the considered MBU (or bundle) as selected and updates the values of other unselected and available MBUs and geo-unit coverage resulting from the selection. Subsequently, optimization module 212 proceeds to decision block 1802 to begin a new iteration.

Decision block 1822 questions whether the considered MBU passes all constraints except for a minimum volume requirement for a newspaper. If the answer is yes, then optimization module 212 proceeds to block 1824. If the answer is no, then optimization module 212 proceeds to decision block 1826.

Block 1824 builds a bundle of MBUs in an attempt to satisfy the minimum volume requirement. It should be appreciated that bundling refers to gathering together a number of MBUs for consideration as a bundled MBU for purposes of satisfying a minimum volume requirement. Subsequently, optimization module 212 proceeds to decision block 1828. Decision block 1828 questions whether the bundle is feasible to all constraints. If the answer is yes, then optimization module 212 proceeds to block 1820. If the answer is no, then optimization module 212 proceeds to block 1826.

Block 1826 marks the considered MBU (or the MBU bundle) as omitted. Subsequently, optimization module 212 proceeds to decision block 1802 to begin a new iteration.

As mentioned above, the greedy-type algorithm of FIG. 18 ends when no unselected and feasible MBUs exist, as depicted in decision block 1812. Subsequently, optimization module 212 outputs and saves a number of selected media products and a number of MBUs from the execution of the greedy-type algorithm, as depicted by blocks 1820 and 1832 of FIG. 18 and arrow 1804 of FIG. 13.

### VII. Evaluation Module

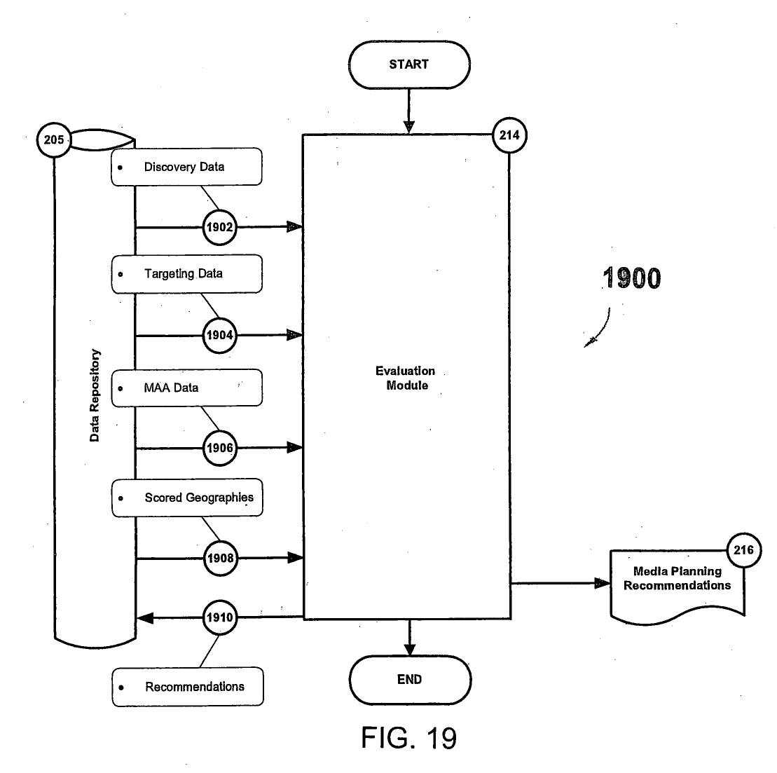

FIG. 19 depicts a process map 1900 relating to evaluation module 214 according to one or more embodiments of the present invention. Evaluation module 214 receives data and information from data repository 205. Such data and information may have been generated by discovery module 202, targeting module 204, MAA module 208 and/or optimization module 212. Arrow 1902 represents discovery data and information generated by discovery module 202, and transmitted to evaluation module 214. Such discovery data and information may include, without limitation, client budget constraint information, client objective information, industry category matrix information, and client preferences information. Arrow 1904 represents targeting data and information generated by targeting module 204, and transmitted to evaluation module 214. Such targeting data and information may include, without limitation, scored geographies, household counts, geo-scores and trade area information. Arrow 1906 represents MAA data and information generated by MAA module 208, and transmitted to evaluation module 214. Such MAA data and information may include all available media options for the geo-units, MBUs and the media footprint. Arrow 1908 represents optimization data and information generated by optimization module 212, and transmitted to evaluation module 214. Such optimization data and information may include an optimized list of MBUs to purchase for each scenario.

Evaluation module 214 is configured to generate media planning recommendation reports 1910 and charts from the received data and information. In one or more embodiments, the reports and charts are evaluated for presentation to the client. Non-limiting examples of reports that can be generated by evaluation module 214 include an executive report, a product detail comparison report, a common geodetail report.

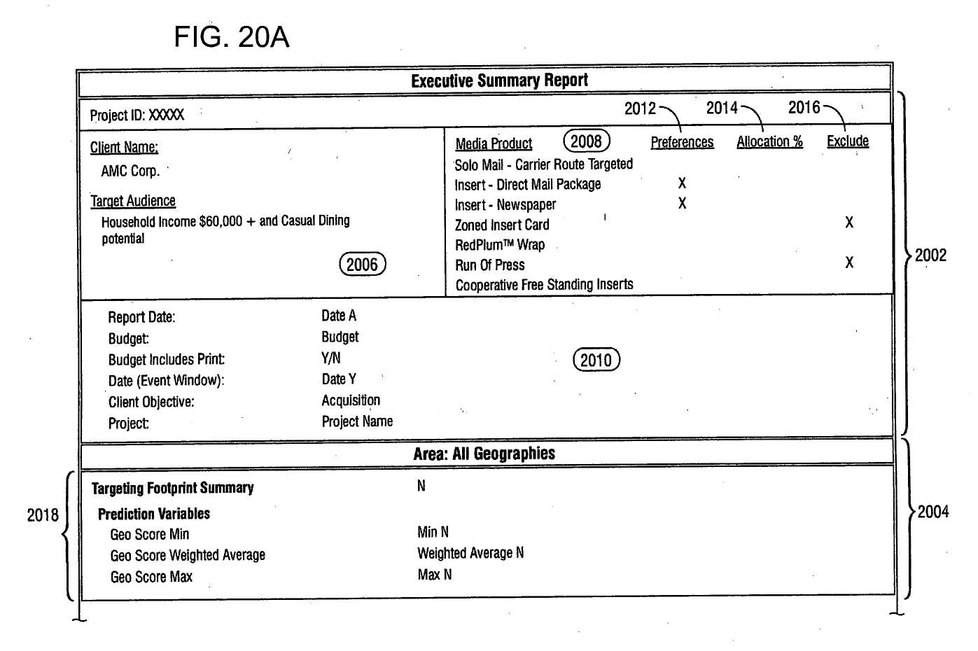

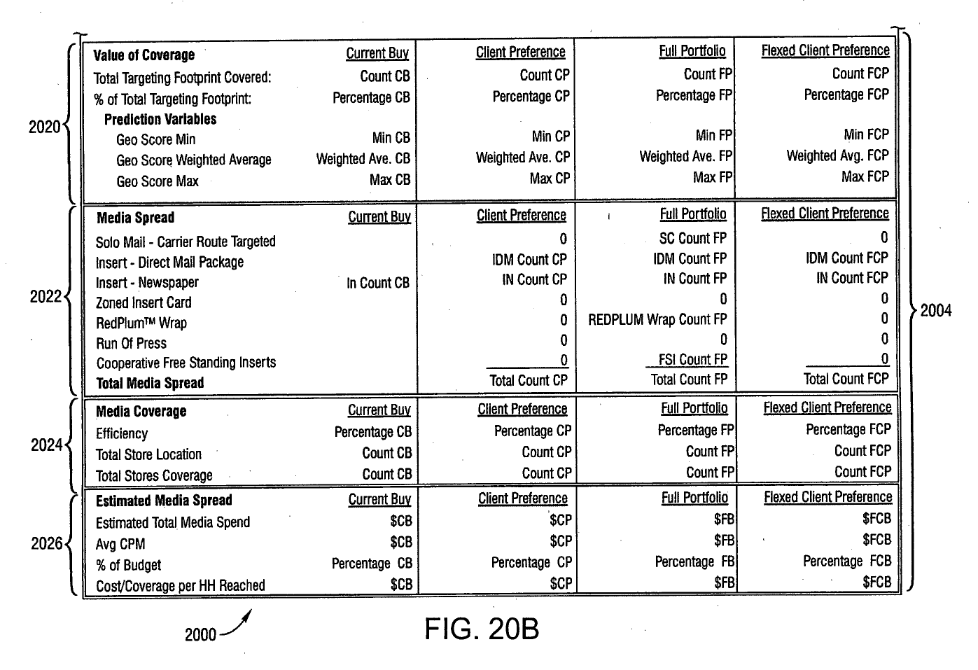

FIGS. 20A and 20B depict an example of an executive summary report 2000 according to one or more embodiments of the present invention. Executive summary report 2000 may be output electronically in an electronic format, such as a portable digital file (“PDF”) or an image file. In other embodiments, executive summary report 2000 may be output in a paper format by utilizing a printer device. In one or more embodiments, executive summary report 2000 includes header section 2002 and analysis section 2004.

The header portion 2002 includes an upper left area 2006, an upper right area 2008, and lower area 2010. The upper left area 2006 includes the client name and a target audience definition. As shown in FIG. 20A, upper right area 2008 includes information relating to the client's selections and exclusions of tier one media products from one or more media planning scenarios. Area 2008 identifies whether such products were selected as client preferred products during the execution of the discovery module 202, by including an “X” in the client preferred column 2012. Such preferred product indicators are used by evaluation module 214, which is configured to carry out client preferred and flexed client preferred analysis based on the preferred product selections.

Area 2008 also includes a percent of budget allocated column 2014 and an excluded product column 2016. The percent of budget allocated column 2014 shows the percent of budget allocated to each tier one media product. In one or more embodiments, column 2014 is optional, and applies only to those reports including results of the client preferred analysis or flexed preferred analysis. The excluded product column 2016 includes an “X” next to any media product that was specifically excluded from the full portfolio analysis by the client during execution of discovery module 202. The lower area 2010 of report 2000 includes the client budget, the client's objective and the promotional period used in the analysis.

The analysis portion 2004 includes a targeting footprint summary 2018, value of coverage analysis 2020, media spread analysis 2022, media coverage analysis 2024 and media spend analysis 2026. The analysis section 2004 may include data for a specified geometry, such as all geographies analyzed, specific market, or a specific store or specific client location. Targeting footprint summary 2018 contains a count (N) of deliverable addresses for all carrier routes within the trade area analyzed and includes one or more summarized values of the geoscores used in the analysis to rank the targeted geographies. The one or more summarized values include, without limitation, sum, minimum (Min N), maximum (Max N), average and weighted average (Weighted Ave N).

The value of coverage analysis 2020 includes a count of deliverable addresses for all carrier routes covered by the media product selected and within the targeting footprint. Analysis 2020 also includes one or more summarized values, such as sum, minimum, maximum, average or weighted average, for the geoscore used in the analysis to rank the targeted geographies. Such summarized values can be provided for a client's current buy (CB), client preference (CP), full portfolio (FP) and flexed client preference (FCP). In one or more embodiments, client's current buy refers to a client's current or past placement of media services. The summarized values can be used to compare a client's current buy, client preference, full portfolio and/or flexed client preference on a single report. The value of coverage analysis 2020 also includes total targeting footprint covered value divided by the count of deliverable addresses for all carrier routes.

Media spread analysis 2022 includes media circulation counts, such as solo mail (Sc Count), direct mail insert (Idm Count), newspaper insert (In Count), REDPLUM wrap (REDPLUM Wrap Count) and FSI (FSI Count), for each of the media products considered in each of the media planning scenarios.

Media coverage analysis 2024 includes media circulation counts for each of the media planning scenarios. The efficiency value (Percentage) is calculated by dividing the targeting footprint covered count by the total media spread. Analysis 2024 also includes a summary of the total number of store locations included in the analysis as well as the number of stores that have one or more carrier routes covered by a selected media product.

Media spread analysis 2026 contains the estimated spend in dollars ($) for each media planning scenario. Average cost per thousand (“CPM”) is calculated by dividing the estimated spend by total media spread multiplied by 1,000. The CPM may not reflect an actual CPM rate for any one product. For example, the CPM for a REDPLUM wrap may be the cost of delivering an advertisement to 1,000 households as part of the wrap. As another non-limiting example, the CPM for a CSI may be the cost of distribution because the client will have already printed and delivered the insert. The % of budget (Percentage) is calculated by dividing the estimated spend by event budget listed in the event summary. The cost per households reached ($) is calculated by dividing the targeting footprint covered count by the estimated spend in dollars.

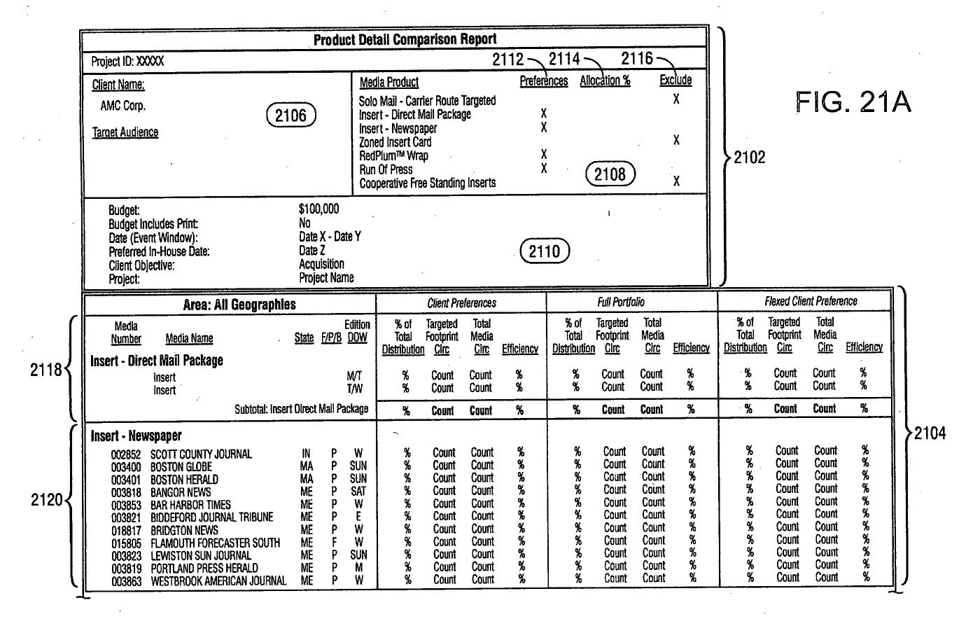

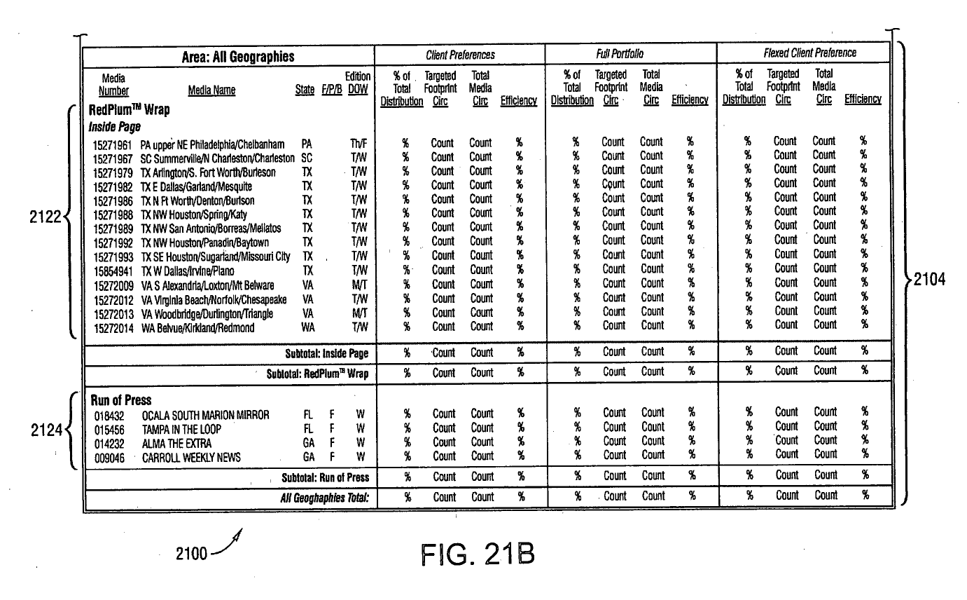

FIGS. 21A and 21B depict an example of a portion of a product detail comparison report 2100 according to one or more embodiments. Product detail comparison report 2100 may be output electronically in an electronic format, such as a portable digital file (“PDF”) or an image file. In other embodiments, product detail comparison report 2100 may be output in a paper format by utilizing a printer device. In one or more embodiments, product detail comparison report 2100 includes header section 2102 and analysis section 2104.

The header portion 2102 includes an upper left area 2106, an upper right area 2108, and lower area 2110. The upper left area 2106 includes the client name and a target audience definition. As shown in FIG. 21A, upper right area 2108 includes information relating to the client's selections and exclusions of tier one media products from one or more media planning scenarios. Area 2108 identifies whether such products were selected as client preferred products during the execution of the discovery module 102, by including an “X” in the client preferred column 2112. Such preferred product indicators are used by evaluation module 214, which is configured to carry out client preferred and flexed client preferred analysis based on the preferred product selections.

Area 2108 also includes a percent of budget allocated column 2114 and an excluded product column 2116. The percent of budget allocated column 2114 shows the percent of budget allocated to each tier one media product. In one or more embodiments, column 2114 is optional, and applies only to those reports including results of the client preferred analysis or flexed preferred analysis. The excluded product column 2116 includes an “X” next to any media product that was specifically excluded from the full portfolio analysis by the client during execution of discovery module 202. The lower area 2110 of report 2100 includes the client budget, the client's objective and the promotional period used in the analysis.

Product detail comparison report 2100 may include a product detail section for a number of media products, such as the tier one media products identified in one or more embodiments. As depicted in FIGS. 21A and 21B, comparison report 2100 includes a product detail section for direct mail packages 2118, newspaper inserts 2120, REDPLUM wrap 2122, and ROP 2124. The analysis section 2104 may include data for a specified geometry, such as all geographies analyzed, specific market, or a specific store or specific client location. Regarding the newspaper insert detail section 2120, the abbreviations “F”, “P” or “B” may be used to denote whether the newspaper circulation is free (e.g., no paid subscribers, paid (e.g., subscribers pay to receive, and also may include street sales) or both (e.g., newspapers and sold and given away). The “Edition DOW” column in the product detail sections 2118, 2120, 2122 and 2124 refers to either the newspaper edition or delivery day of the week. In one or more embodiments, the newspaper edition is selected from the following group: morning (“M”), evening (“E”), weekly (“W”), Saturday (“SAT”) or Sunday (“SUN”). In one or more embodiments, mailed products will show a two-day delivery window.

Each detail section includes % of total distribution, targeted footprint circulation, total media circulation and efficiency for each media buyable unit present in columnar format. In one or more embodiments, such information is presented for each of the media planning scenarios, such as client preference, full portfolio and flexed client preference. % of total distribution is calculated by dividing the total media circulation for the media buyable unit by the total media circulation for the media product. The targeted footprint circulation represents the estimated circulation for each media product that meets a number of targeting objectives or parameters within the targeting footprint. The % efficiency is calculated by dividing the targeted footprint circulation by the media circulation.

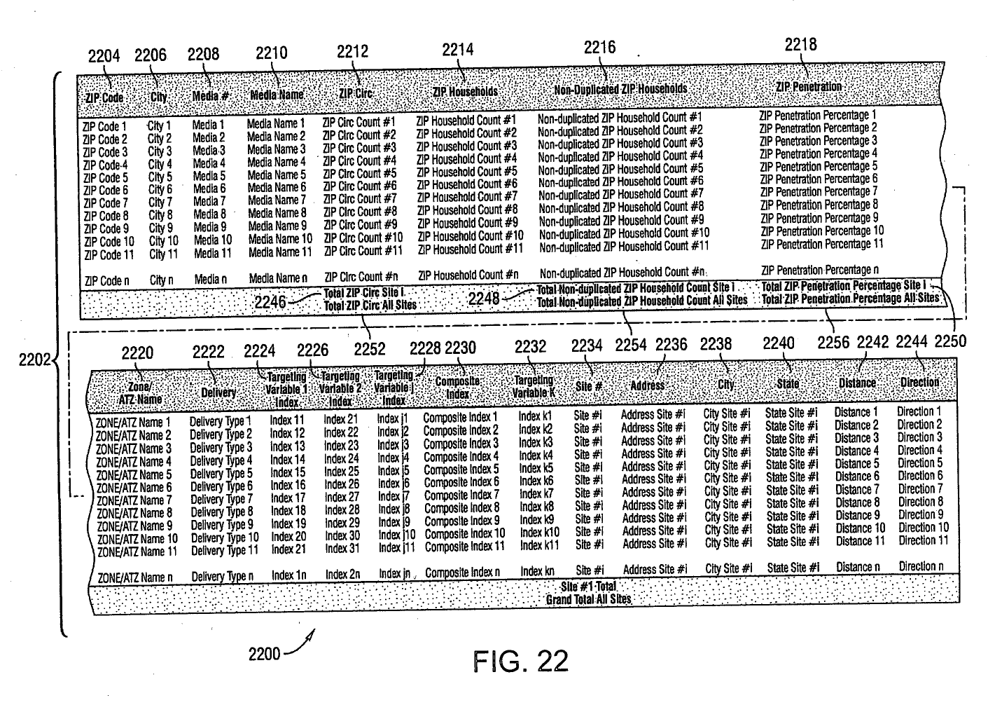

FIG. 22 depicts an example of a portion of a common geodetail report 2200 according to one or more embodiments. The common geodetail report 2200 may be output electronically in an electronic format, such as a portable digital file (“PDF”) or an image file. In other embodiments, common geodetail report 2200 may be output in a paper format by utilizing a printer device.

The common geodetail report 2200 includes a listing of specific media products and related information of a recommended media plan. As depicted by FIG. 22, each row of media product section 2202 represents a specific medial product within site i. Each row of media product section 2202 includes information related to the specific media product. As depicted in FIG. 22, the related information includes ZIP Code 2204 of each media product, city 2206 of each media product, media number 2208 of each media product, media name 2210 of each media product, ZIP Code circulation count 2212 for the ZIP Code associated with each media product, ZIP Code household count 2214 for each ZIP Code associated with each media product, non-duplicated ZIP Code household count 2216 for each ZIP Code associated with each media product, ZIP Code penetration percentage 2218 for each ZIP Code associated with each media product, zone or ATZ name 2220 associated with each media product, delivery type 2222 of each media product, targeting variable 1 index value 2224 for each media product, targeting variable 2 index value 2226 for each media product, targeting variable j 2228 for each media product, composite index 2230 for each media product, targeting variable K 2232 for each media product, site number 2234 for each media product, address of site i 2236, city of site i 2238, state of site i 2240, distance 2242 between the ZIP Code of each media product and site i, and direction 2244 from site i to the ZIP Code of each media product.

Non-limiting examples of targeting variables include household income of $60K+ and casual dining index. A non-limiting example of targeting variable K is median household income.

The total zip circulation count 2246 is provided for site i according to common geodetail report 2200. The total non-duplicated ZIP Code household count 2248 is provided for site i according to common geodetail report 2200. The total ZIP Code penetration percentage 2250 is provided for site i according to common geodetail report 2200.

The total zip circulation count 2252 is provided for all sites according to common geodetail report 2200. The total non-duplicated ZIP Code household count 2254 is provided for all sites according to common geodetail report 2200. The total ZIP Code penetration percentage 2256 is provided for all sites according to common geodetail report 2200.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An automated computer system for determining geographically-localized estimated sales data for use in generating media plans and comprising a computer having a central processing unit (CPU) for executing machine instructions and a memory for storing machine instructions that are to be executed by the CPU, the machine instructions when executed by the CPU implement the following functions:
receiving sales data from a client for a number of ZIP Codes;
performing lifestyle cluster analysis on the sales data of the client for the number of ZIP Codes to obtain lifestyle cluster data for each of the number of ZIP Codes;
receiving information for a number of carrier routes for each of the number of ZIP Codes;
calculating a lifestyle cluster index for each of the number of ZIP Codes and each of the number of carrier routes for each of the number of ZIP Codes based on the lifestyle cluster data for each of the number of ZIP Codes and the information for the number of carrier routes;
appending household base counts to each of the number of ZIP Codes and each of the number of carrier routes;
calculating actual sales per household for each of the number ZIP Code based on the sales data from the client for the number of ZIP Codes and the household base counts for the number of ZIP Codes; and
calculating estimated total sales per household for each of the number of carrier routes based on the actual sales per household for the ZIP Code associated with the carrier route being considered, the lifestyle cluster index for the carrier route being considered, and the lifestyle cluster index for the ZIP Code associated with the carrier route being considered.

2. The computer system of claim 1, wherein the third calculating function includes calculating estimated total sales per household for each of the number of carrier routes by multiplying the lifestyle cluster index for the carrier route being considered by the ratio of the actual sales per household for the ZIP Code associated with the carrier route being considered to the lifestyle cluster index for the ZIP Code associated with the carrier route being considered.

3. The computer system of claim 2, wherein the machine instructions when executed by the CPU further implement the following function: calculating estimated total sales for each of the carrier routes based on the estimated total sales per household for the carrier route being considered and the household base count of the carrier route being considered.

4. The computer system of claim 1, wherein the lifestyle cluster data is comprised of a number of lifestyle clusters.

5. The computer system of claim 1, wherein the machine instructions when executed by the CPU further implement the following function: cleansing the sales data from the client for a number of ZIP Codes against a master ZIP Code file.

6. The computer system of claim 1, wherein the household base counts to each of the number of ZIP Codes or each of the number of carrier routes is the highest base count during a specified date range.

7. An automated computer system for determining a relative value of a localized geography to a media plan and comprising a computer having a central processing unit (CPU) for executing machine instructions and a memory for storing machine instructions that are to be executed by the CPU, the machine instructions when executed by the CPU implement the following functions:
receiving a localized geography and a number of localized geography types;
associating one of the localized geography types to the localized geography to obtain an associated localized geography type;
receiving a functional relationship related to the associated localized geography type;
calculating a geo-score for the localized geography based on the functional relationship; and
calculating the relative value of the localized geography based on the geo-score and a household base count for the localized geography to determine the relative value of the localized geography.

8. The computer system of claim 7, wherein the associated localized geography type is selected from the group consisting of: trade area, distance from a site, demographic characteristic, demographics/distance, sales, customer behavior, past media promotion responsiveness and custom.

9. The computer system of claim 8, wherein the associated localized geography type is distance from a site and the functional relationship is a distance scaling factor.

10. The computer system of claim 8, wherein the associated localized geography type is demographic characteristic and the functional relationship is a composite demographic index.

11. The computer system of claim 8, wherein the associated localized geography type is sales and the functional relationship is average sales per household.

12. The computer system of claim 8, wherein the localized geography is selected from the group consisting of: a carrier route, a ZIP Code, an advertising trade zone, a wrap zone or a newspaper zone.

13. An automated computer system for generating a media buyable unit (MBU) score for use in generating a geographically-localized media plan and comprising a computer having a central processing unit (CPU) for executing machine instructions and a memory for storing machine instructions that are to be executed by the CPU, the machine instructions when executed by the CPU implement the following functions:
receiving a geography to be included in a geographically-localized media plan;
receiving information relating to a first and second media product available within the geography;
receiving an activation score for the first media product based on the information relating to the first and second media products, the activation score indicating the value of the first media product relative to the second media product;
receiving a household value score indicative of the value of the geography;
receiving a sell price for the first media product within the geography; and
calculating an MBU score for the first media product based on the activation score, the household value score and the sell price.

14. The computer system of claim 13, the machine instructions when executed by the CPU further implement the following function: receiving a coverage value for the first media product within the geography, and the calculating function includes calculating the MBU score based on the activation score, the household value score, the coverage value and the sell price.

15. The computer system of claim 13, the machine instructions when executed by the CPU further implement the following functions: receiving a number of in-home dates for the first media product and a client preferred date for delivery of the first media product and determining an alignment value based on the number of in-home dates and the client preferred dates, and the calculating the MBU score based on the activation score, the household value score, the alignment value and the sell price.

16. The computer system of claim 13, wherein the geography is selected from the group consisting of a carrier route, advertising trade zone or a ZIP Code.

17. The computer system of claim 13, the machine instructions when executed by the CPU further implement the following functions: receiving a client objective for the geographically-localized media plan and calculating the activation score based on the client objective and the information relating to the first and second media products.

18. The computer system of claim 13, the machine instructions when executed by the CPU further implement the following function: calculating the household value score based on the geography.

19. The computer system of claim 13, the machine instruction when executed by the CPU further implement the following functions: receiving a geography type associated with the geography and calculating the household value score based on the geography and geography type.

20. The computer system of claim 13, wherein the household value score is independent of the first or second media products.
